(19) United States
(12) Patent Application Publication
(10) Pub. No.: US 2007/0233879 A1
(43) Pub. Date: Oct. 4, 2007

(54) System and method for advertisement identification, selection, and distribution involving a peer-to-peer network

(76) Inventors: Steven Woods, Los Altos Hills, CA (US); David Simons, Toronto (CA); Kelly Slough, Northampton, MA (US)

Correspondence Address: FOLEY & LARDNER LLP, 150 EAST GILMAN STREET, P.O. BOX 1497, MADISON, WI, 53701-1497, US

(21) Appl. No.: 11/544,449

(22) Filed: Oct. 6, 2006

Related U.S. Application Data
(60) Provisional application No. 60/725,173, filed on Oct. 7, 2005.

(51) Int. Cl. G06F 15/16

(52) U.S. Cl. 709/227

(57) ABSTRACT

A method of presenting an advertisement to a user executing content at a device is provided. A request for content is sent to a device in a peer-to-peer (P2P) network. A file is received from the P2P network. The file includes the content requested and a campaign file. The campaign file includes information identifying when and which advertisements are presented to a user during execution of the requested content. The received file is installed and the requested content is executed. A time is determined for presenting an advertisement based on information read from the campaign file. At the determined time, the advertisement is requested and presented. The advertisement itself is delivered either in-advance of a request or on demand in response to a request as determined by the campaign file. The advertisement is delivered from either the content-requesting device, a peer or server in the P2P network, or a third party Internet delivery service. As an example, an Internet consumer requests a streamed video and receives as part of the stream a campaign file outlining the types of advertisements relevant to the video, and where to play them. The consumer's previous requests may result in the pre-delivery of advertisements. One of these available advertisements is selected for display during the playback of the video.

### CROSS REFERENCE TO RELATED APPLICATION

This non-provisional application claims priority based upon U.S. Provisional Patent Application No. 60/725,173, filed Oct. 7, 2005, entitled MANAGING APPLICATIONS USING PEER TO PEER CONNECTIVITY, the entire disclosure of which is hereby incorporated by reference in its entirety and for all purposes. This application relates to U.S. patent application Ser. No. ______ (Atty. Dkt. No. 046185-0102), entitled SERVICE AND MESSAGING INFRASTRUCTURE TO SUPPORT CREATION OF DISTRIBUTED, PEER TO PEER APPLICATIONS WITH A SERVICE ORIENTED ARCHITECTURE, and having inventors Steven Woods, David Simons, Kelly Slough, Mike lies, Patrick McMorris, Jeromy Carriere. This application further relates to U.S. patent application Ser. No. ______ (Atty Dkt. No. 046185-0111), entitled SYSTEM AND METHOD FOR PROVIDING CONTENT, APPLICATIONS, SERVICES, AND DIGITAL MEDIA TO USERS IN A PEER-TO-PEER NETWORK, and having inventors Steven Woods, David Simons, Kelly Slough, Mike Iles.

### FIELD OF THE INVENTION

The present invention is related to the distribution of information across a network. More specifically, the present invention relates to advertisement distribution in a peer-to-peer network.

### BACKGROUND OF THE INVENTION

This section is intended to provide a background or context to the invention recited in the claims. The description herein may include concepts that could be pursued or may have been pursued, but are not necessarily ones that have been previously conceived or pursued. Therefore, unless otherwise indicated herein, what is described in this section is not prior art to the description and claims in this application and is not admitted to be prior art by inclusion in this section.

U.S. Patent Application Publication No. 2004/0148221 to Chu indicates that “[g]ame advertisements are generally produced by the game publishers or advertisers to which the game publisher has sold the ad locations and opportunities. The publishers or advertisers may require game players to match an exemplary profile or to fulfill certain game requirements before game players may view specific advertisements or promotions. For example, a player must have accumulated a certain amount of points or playing time before being allowed to view an advertisement for a more sophisticated weapon to be used within the game or a player must 21 years or older to be allowed to view the advertisement that contains a free coupon for a six pack of beer. Such requirements are enforced via encrypted keys or other secure methods to check a users qualification before displaying of certain advertisements . . . Other advertisements are available to all players willing to view them. Some advertised products are available for “purchase” using points, but others require the use of real currency.” (Para. [0043.)

U.S. Patent Application Publication No. 2004/0148221 to Chu continues to say that “[a]dvertisements displayed within the virtual billboard are viewed according to rules established by either the advertisers or game publishers. The rules are accessible and enforced by either the remote server . . . Example rules include, for example, that advertisements may only be viewed during specified time intervals, according to fluctuating supply levels, or determined by a sequence of actions taken by the game character in relationship to the advertisement. For example, a beer ad may be specified to viewed in the evening, whereas a coffee ad is displayed in the morning and an ad displaying a coupon for a free movie ticket may be displayed only to the first 1000 game players who select the advertisement. In another example, an advertisement containing a coupon for a free movie ticket is only displayed if a game player directs his character to jump three times around the circumference of the billboard displaying the ad or throws a tomato at the center of the billboard.” (Para [0044].)

### SUMMARY OF THE INVENTION

An exemplary embodiment of the invention relates to a method of presenting an advertisement to a user executing content at a device. The method may include sending a request for a first content to a device in a peer-to-peer (P2P) network; receiving a file from the device using the P2P network, wherein the file includes the first content and a campaign file; installing the received file; executing the first content; determining a time to present an advertisement based on information read from the campaign file; at the determined time, requesting the advertisement; and presenting the requested advertisement.

An exemplary embodiment of the invention relates to a method of controlling presentation of an advertisement to a user obtaining content from a network. The method may include, receiving a request for a first content from a device; and sending a file to the device using a peer-to-peer (P2P) network, wherein the file includes the first content and a campaign file, the campaign file including information used to identify a time to present an advertisement to a user at the device. The file includes programmed instructions to install the sent file at the device; execute the first content; and present the advertisement at the device at the identified time as the user executes the first content.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is a block diagram of an agent infrastructure that includes a messaging and service infrastructure and that can be instantiated at a device to provide P2P connectivity in accordance with an exemplary embodiment.

FIG. 2 depicts a P2P system that includes devices implementing the agent infrastructure of FIG. 1 in accordance with an exemplary embodiment.

FIG. 3 depicts agent communication between devices in a P2P network in accordance with an exemplary embodiment.

FIG. 4 depicts a server system in a P2P network in accordance with an exemplary embodiment.

FIG. 5 is a flow diagram of operations associated with the messaging and service infrastructure of FIG. 1 in accordance with an exemplary embodiment.

FIG. 6 is a block diagram of a client agent infrastructure and a server agent infrastructure that manage installed software applications using the messaging and service infrastructure of FIG. 1 in accordance with an exemplary embodiment.

FIG. 7 illustrates a user interface window presented to an installation manager by a content management server application in accordance with an exemplary embodiment.

FIG. 8 illustrates more detailed information accessible using the user interface window of FIG. 7 in accordance with an exemplary embodiment.

FIG. 9 illustrates a manifest associated with application publication by the content management server application in accordance with an exemplary embodiment.

FIG. 10 is a flow diagram of operations associated with application publication by the content management server application in accordance with an exemplary embodiment.

FIG. 11 depicts a content distribution system in accordance with an exemplary embodiment.

FIG. 12 illustrates a first user interface window of the content user interface application presenting content available from the local device to a content consumer in accordance with an exemplary embodiment.

FIG. 13 illustrates a second user interface window of the content user interface application presenting content available from the network to a content consumer in accordance with an exemplary embodiment.

FIG. 14 is a block diagram of a device instantiating the agent infrastructure of FIG. 1 in accordance with an exemplary embodiment.

FIG. 15 is a flow diagram of operations associated with obtaining content from the content server device of FIG. 11 in accordance with an exemplary embodiment.

FIG. 16 is a flow diagram of operations associated with receiving content at the content consumer device of FIG. 11 in accordance with an exemplary embodiment.

FIG. 17 is a flow diagram of operations associated with controlling advertisement presentation at the content consumer device of FIG. 11 in accordance with an exemplary embodiment.

### DETAILED DESCRIPTION OF EXEMPLARY EMBODIMENTS

Exemplary systems and methods are provided for connecting peers in a peer-to-peer (P2P) network and for utilizing the peers in the P2P network to acquire and update content from other peers. Systems and methods of managing applications are provided that include application management software to enable the fast, secure deployment, update, and monitoring of software applications using a highly scalable P2P network technology. Through use of the systems and methods, an application can be placed under central control to provide automatic installation, update, and monitoring of the application running on systems located on any size network whether the system is occasionally connected to the network at different locations, is behind firewalls, or is accessible over the Internet. As a result, application lifecycle costs are lowered through the elimination of manual updates and the shipment of CDs to users. Other types of content also may be installed, updated, and monitored using the systems and methods provided herein including, games, movies, music, etc. Advertisements also may be distributed to peers in the P2P network either under central control or under control at the peer, for example when the peer is disconnected from the P2P network.

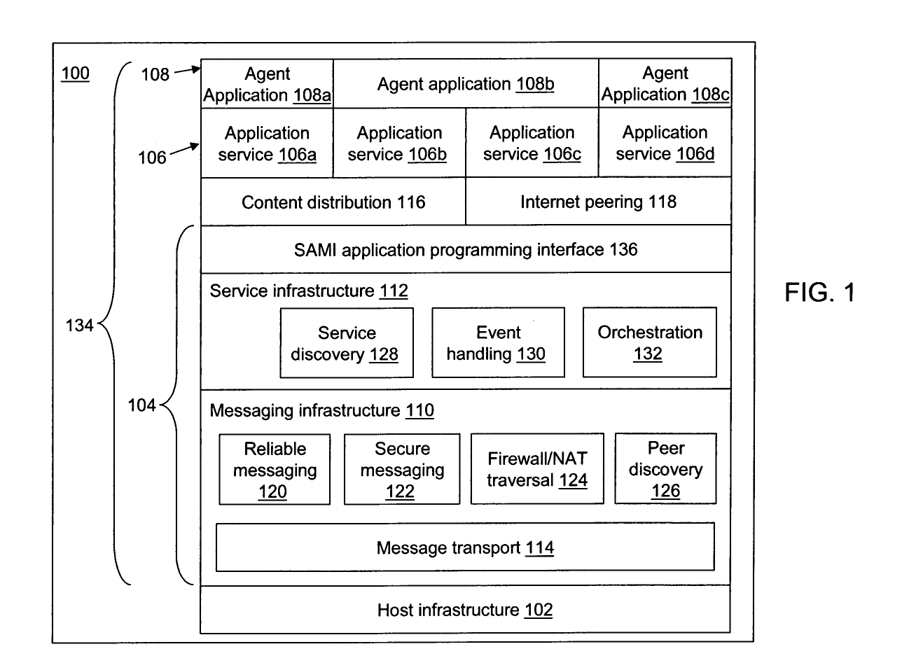

With reference to FIG. 1, an exemplary software architecture 100 is shown which supports the P2P distribution of content in a network. Software architecture 100 includes a host infrastructure 102, a service and messaging infrastructure (SAMI) 104, a content distribution component 116, an internet peering component 118, one or more application services 106, and one or more agent applications 108. The elements of software architecture 100 include sets of instructions that, when executed, cause a computing device to behave in a predetermined manner. For example, the one or more agent applications 108 may provide the computing device with the ability to perform a wide variety of tasks including allowing a user of the computing device to draft documents, to communicate with others, to prepare presentations, to present presentations, to create movies and music files, to play movie and audio files, to access information from the Internet, to update a version of an application, to maintain a schedule, etc. The behavior may or may not be under the control of a user of the computing device. Thus, some behavior may be performed automatically without a user being logged into the computing device.

The instructions may be written using one or more programming languages, assembly languages, scripting languages, etc. For the instructions to execute, the instructions may be translated into a machine language that the computing device can understand. Alternatively, no translation may be required. Host infrastructure 102, in an exemplary embodiment, includes an operating system and a platform independent framework as known to those skilled in the art both now and in the future.

Exemplary software architecture 100 includes a first agent application 108a, a second agent application 108b, and a third agent application 108c. Agent application functionality can be decomposed into a collection of services. The collection of services are implemented based on the problem domain of the agent application. Thus, each of the one or more agent applications 108 has one or more application service associated with it that controls execution of a particular type of functionality of the agent application as known to those skilled in the art both now and in the future. The application services 106 may be implemented as a Windows® service. An application service may include a collection of components defined as capabilities. In the exemplary embodiment of FIG. 1, first agent application 108a utilizes a first application service 106a; second agent application 108b utilizes a second application service 106b and a third application service 106c; and third agent application 108c utilizes a fourth application service 106d.

An agent infrastructure 134, in an exemplary embodiment, includes SAMI 104, content distribution component 116, internet peering component 118, at least one of the application services 106, and at least one of the agent applications 108. For example, a first agent infrastructure includes third agent application 108c and application service 106d. A second agent infrastructure includes second agent application 108b, second application service 106b, and third application service 106c.

In an exemplary embodiment, agent infrastructure 134 is implemented as a .NET process containing a number of AppDomains where an AppDomain is a lightweight process that may be a .NET feature. The primary purpose of the AppDomain is to isolate an agent application from other applications. In general, one AppDomain is created to host each of the major functional components of agent infrastructure 134. Thus, the one or more application services 108 may be created by an application developer and hosted in a separate AppDomain. In an exemplary embodiment, the instructions that comprise agent infrastructure 134 are executed in the common language runtime (CLR) environment that manages the execution of .NET program code.

An agent is an instance of the agent infrastructure 134 executing at the computing device. One or more agents may be instantiated at the computing device. The one or more application services 106 are deployed to and execute in the agent which is a container of services and can be considered an application server. Thus, the agent provides an environment for the one or more application services 106 to execute in. As a result, it is responsible for resource management of the process (thread management, memory management) and for providing monitoring hooks (performance counters, logging, etc.) for the one or more application services 106 and/or one or more agent applications 108.

SAMI 104, content distribution component 116, and internet peering component 118 facilitate the distribution of information in a P2P network. SAMI 104 may include a SAMI application programming interface (API) 136. The SAMI API 136 is a collection of high-level APIs that allow application developers to easily and effectively use SAMI 104. In an exemplary embodiment, SAMI API 136 utilizes a capability model that identifies a collection of capabilities. In an exemplary embodiment, a capability is a .NET managed-code assembly that runs in the .NET CLR. In general, a capability is a small amount of application logic wrapped in a .NET assembly. A capability can move from a server to a peer, from a peer to a server, or from a peer to a peer while retaining its state. This functionality supports the creation of mobile applications that execute whether the computing device is connected to a network or not. Capabilities also can be updated on a system invisibly to the user. In an exemplary embodiment, capabilities can be created by developing the application using the templates and class libraries provided with Visual Studio.NET.

The SAMI API 136 allows dynamic instantiation, activation, and deactivation of capabilities. An agent application invokes a capability by making a capability use request (CapUseReq). Each capability is paired with one or more classes derived from a CapUseReq. A CapUseReq class contains the parameters for a request to use a capability. A new capability class has at least one method, for example, ServiceRequest, with a single CapUseReq parameter. This method provides an entry point into an application service of the agent application. Capabilities can define multiple ServiceRequest methods with different CapUseReq parameters allowing one capability to service a number of different requests. There is a single CapUseReq for each public ServiceRequest method exposed by the capability. One application service requests another application service by creating and executing an instance of the CapUseReq class.

In an exemplary embodiment, an application service is created by deriving a new capability class from an abstract base class. The following example shows an application-defined capability, WorkerCapability, derived from the SAMI.Capability base class.

```
public class WorkerCapability : SAMI.Capability
{
  public WorkerResponse ServiceRequest (WorkerCapUseReq
  capUseReq)
  {
    // Insert implementation here
    return (workerResponse);
  }
}
```

In an exemplary embodiment, a CapUseReq is a .NET type created using templates within Visual Studio produced by Microsoft Corporation. Because it defines the specific interface for the particular ServiceRequest method, a CapUseReq may be built in an assembly separate from the capability itself. The following example shows an application-specific CapUseReq class:

```
public class WorkerCapUseReq : SAMI.CapUseReq
{
  public WorkerCapUseReq (string workerParam)
  {
    private string_workerParam;
    public string WorkerParam
    {
      get { return (_workerParam); }
    }
  }
}
```

SAMI 104 includes a messaging infrastructure 110 and a service infrastructure 112. The service infrastructure 112 is implemented as a layer built on top of the messaging infrastructure 110. The messaging infrastructure 110 includes a message transport component 114, a reliable, messaging component 120, a secure messaging component 122, a firewall/network address translator (NAT) traversal component 124, and a peer discovery component 126. Messaging infrastructure 110 provides reliable, IP-independent messaging that scales to a large numbers of nodes and operates effectively in an occasionally-connected environment. In addition, messaging infrastructure 110 implements peering features designed to reduce load on a peer management server.

Message transport component 114 sends and receives messages sent between agents. A local agent is an instance of agent infrastructure 134 that executes at the computing device and that instantiates one or more application service. A peer agent is an instance of agent infrastructure 134 that executes at another computing device. To send a message between two agents, a connection between the two devices hosting the agents is established, and a mechanism for transporting messages across the connection is negotiated. In an exemplary embodiment, message transport component 114 sends and receives simple object access protocol (SOAP) messages produced by serializing .NET objects across a .NET bi-directional transmission control protocol (TCP) remote channel. In an alternative embodiment, message transport component 114 sends and receives Web services description language (WSDL) describable messages using bi-directional TCP, bi-directional hypertext transport protocol (HTTP), and/or polling HTTP transports. As an example, after receiving a WSDL document, the agent may send a SOAP message to activate an application service. The application service returns a SOAP message in response. Other methods for achieving a similar response include the common object request broker architecture and the distributed component object model. Messages can be assigned priorities which may be used to determine the order in which messages are sent. Prioritization may be important in low-bandwidth scenarios, for example, so that control messages are sent ahead of bulk-data messages.

At the level of SAMI API 136, the message may be an instance of a CapUseReq class. The CapUseReq instance is wrapped in an envelope at the network layer with information such as a globally unique identifier (GUID) to identify the computing device and/or the receiving device of the message. Message transport component 114 may enclose the envelope in a frame that indicates the byte size of the message. Communication between a local agent and a peer agent may be initiated with a handshake. The message may be sent as a bi-directional TCP frame. Communication stops when either device terminates the connection.

Application services communicate using reliable messaging component 120. Each peer agent participating in an agent application may implement a local store and forward queue in its messaging infrastructure 110. IP independence is accomplished using the GUID to identify the computing device. Because the IP address of a peer agent can change over the course of a single application session, for example, if the user is moving between different wireless networks, an IP address-independent routing mechanism enables the application to continue to function without interruption across such network transition events. The GUID is established at the computing device during the instantiation of the agent and does not change while the agent infrastructure 134 is installed on the computing device. Thus, using messaging infrastructure 110, a message is sent between agents using a GUID for the destination device instead of an IP address. In an exemplary embodiment, the GUID may be an instance of the System.Guid structure of the .NET platform. Messages can be sent with an option for guaranteeing the transmission order to ensure that the messages are processed by the recipient in the same order in which they were sent by the sender.

Messaging infrastructure 110 includes logic to maintain routing information so that messages can be efficiently routed between nodes using the optimal path. This routing logic effectively self-organizes the network to take advantage of whatever ad-hoc connections exist between agents. In an exemplary embodiment, the routing logic implements a routing information protocol algorithm encapsulated above the message transport component 114 to allow alternative routing algorithms to be implemented or to co-exist within the same network.

Two exemplary routing strategies include a routing information protocol (RIP) algorithm, which propagates knowledge of all agents within a subnet to allow routing between all connected peers, and a ‘one-hop’ algorithm, which allows agents to benefit from services provided by their immediate neighbors without knowledge of agents further away. The RIP algorithm is appropriate for smaller groups of agents in which routing between all agents in offline scenarios is important; whereas the one-hop algorithm is appropriate for larger-scale scenarios in which routing between agents is not as important as opportunistic access to services provided by neighboring agents.

The computing device may also maintain knowledge about a peer management server to which the computing device may connect. The peer management server can be used as a temporary storage point for a message sent to an agent that is not currently connected to the P2P network. For example, if a second agent is not connected to the P2P network and a first agent sends a message to the second agent, the peer management server stores the message until the second agent connects to the P2P network. Alternatively or possibly additionally, the first agent may store the message to the second agent in its own local store and forward queue for delivery when the second agent reconnects to the network. In yet another alternative the message may be stored at another peer agent in the P2P network.

Secure messaging component 122 can authenticate and authorize all message senders and reject any unauthorized messages. The secure messaging component 122 provides a mechanism for securing message traffic between peers in the P2P network. The secure messaging component 122 may leverage existing security policies and processes within an enterprise and .NET security features such as code access security. In an exemplary embodiment, .NET remoting is used to communicate between agents. In an alternative embodiment, Web services enhancements and X.509 certificates are used to secure the messaging traffic to provide end-to-end security between agents. For example, each agent may have an X.509 certificate issued and associated with it based on the GUID of the agent. Message traffic within a data center may be secured using standard Windows® authentication.

The firewall/NAT traversal component 124 allows services running within any two agents to talk to each other regardless of whether the agents are behind a firewall or NAT. In general, at agent startup, a direct bi-directional TCP connection is established between the local agent and a peer agent, a web server, and/or a peer management server. However, if the local agent is behind a NAT, a persistent bi-directional TCP connection is established between the local agent and the peer management server. Based on the persistent bi-directional nature of the connection, the peer management server is capable of sending messages to the local agent from another peer agent despite the NAT. To send a message to the local agent, the peer agent sends the message to the peer management server. The peer management server forwards the message to the local agent using the persistent bi-directional TCP connection.

In a distributed application with thousands of participating agents, it is impractical to persistently establish thousands or even tens of thousands of persistent connections to a single peer management server. In a large deployment, the peer management server may be deployed in clusters. Each agent is given knowledge of every peer management server in the cluster. At startup, an agent hashes its GUID to calculate to which peer management server in the cluster it should connect. An agent connects with the same peer management server in the cluster as long as peer management servers are not added to or removed from the cluster. As a result, an agent may effectively be assigned to a peer management server which acts as its message proxy.

The two-way bi-directional TCP communication channel may not work with restrictive firewalls or proxies that allow only HTTP traffic. In these environments, an HTTP-based transport enables the transmission of messages behind firewalls. The ability to use both communication protocols allows for communication with peer agents behind a firewall/NAT. Additionally, if the agent is behind a firewall that does not allow arbitrary outbound connections, the firewall may be configured to allow outgoing connections on a fixed port(s) that the peer management server is using.

In order for agents to establish communication between each other, the agents must know about each other and must have exchanged their GUIDs. Peer discovery component 126 uses user datagram protocol (UDP) broadcasts to identify agents on the same subnet.

Service infrastructure 112 includes a service discovery component 128, an event handling component 130, and an orchestration component 132. Service infrastructure 112 discovers and maintains knowledge of services that are available in an agent executing at another device (peer agent) in the P2P network. Service discovery component 128 extends peer discovery component 126 of messaging infrastructure 110. Service infrastructure 112 registers with messaging infrastructure 110 for notification of peer agents discovered at other devices in the P2P network. When a new peer agent is discovered, a local cache of the services available in the newly discovered peer agent is created, and the new peer agent is requested to provide notification of when services are added and removed so that the local cache can be maintained at the computing device. Service discovery component 128 allows peer agents to share available service knowledge. In a network with a large number of peer agents, a service gateway may be used because, in a large network, it may become impractical for every peer agent to know about every service in every other peer agent.

The local agent may use standard web service discovery protocols to dynamically identify application services running on any web services platform (.NET, J2EE) and may expose them as capabilities. Requests for the identified web services can be made while online or while the computing device is being used offline. Requests made while offline are queued within the local store and forward queue of the agent and reliably executed at the earliest opportunity, even if the application itself is not active at the time. A response from the web service is reliably delivered to the application when it is next active.

By wrapping the web service invocation in a DynamicCapability, any web service can be invoked reliably regardless of the network connectivity status when the request is first made. The WebServiceAccess DynamicCapability can be configured to monitor the availability of a given web service, and activate or deactivate itself, depending on whether or not the web service is available. An application can derive an application specific web service access capability that services a collection of CapUseReq types, each one corresponding to a specific WebMethod exposed in the target web service. For example, first agent application 108a can invoke a web service using the CapUseReq classes.

The following example shows an application-specific web service access capability that wraps a web service designed to accept edits from a client application and to commit the edits to a database. The web service exposes a single WebMethod that accepts an extensible markup language (XML) data structure containing the changes to commit.

```
public class DatabaseWebServiceCapability :
WebServiceAccessCapability
{
  private localhost.SfaDatabase sfaDatabase;
  public DatabaseWebServiceCapability ( ) : base( )
  {
    sfaDatabase = new localhost.SfaDatabase ( );
  }
  public int ServiceRequest (CommitSfaChangesReq commitReq)
  {
    return (sfaDatabase.WriteChange (commitReq.ChangesToCommit));
  }
}
public class CommitSfaChangesReq: SAMI.CapUseReq
{
  public CommitSfaChangesReq (System.Data.DataSet
  dsChanges) : base( )
  {
    _changes = dsChanges;
  }
  private System.Data.DataSet_changes;
  public System.Data.DataSet ChangesToCommit
  {
    get { return (_changes); }
  }
}
```

The following example indicates how first agent application 108a may invoke the capability that wraps the web service. In this example, the DatabaseWebServiceCapability defined above activates and deactivates itself based on a built-in detection of network connectivity status and availability of the target web service. When it is deactivated, any requests made for the capability are queued in the local store and forward queue of the agent persistently until the DatabaseWebServiceCapability detects network connectivity and the availability of the target web service. At this time, the request activates itself whether first agent application 108a is active or not.

CommitSfaChangesReq commitReq=new CommitSfaChangesReq (dsLocalChanges ); commitReq.BeginExec(

CapUseReqExecFlags.WaitForCapability|CapUseReqExecFlags.Reliable,

SAMI.NetworkEntryPoint.EntryPoint.Guid,

new System.AsyncCallback (CommitChangesCallback), null);

When invoking a capability, the Exec or BeginExec method of the CapUseReq object allows the application to specify a set of flags that control the manner in which the request is executed.

| | |
|---|---|
| Default | Specifies the default mode of operation for |
| | executing a CapUseReq. If the capability is |
| | present in the local agent, the capability |
| | is executed there. If not present, the |
| | CapUseReq is forwarded to the peer agent |
| | best able to service the request as determined |
| | by orchestration component 132 of the local agent. |
| MultiUse | The CapUseReqDone callback remains registered |
| | so that it can receive multiple callbacks. |
| | In the absence of this flag, the callback is |
| | removed when the first response is received. |
| Multicast | The CapUseReq is executed on all peer agent's |
| | that are peers of the local agent and that are |
| | able to provide the requested capability. |
| Reliable | The CapUseReq is delivered and executed reliably |
| | to the destination agent. Thus, the requesting |
| | agent will continue to attempt to deliver the |
| | request to the destination agent. The destination |
| | agent acknowledges receipt and processing of a |
| | specific instance of a request, thereby giving |
| | the reliable execution flag once-only semantics |
| | (within a configurable time interval). |
| Secure | The CapUseReq is delivered and executed securely. |
| | A hybrid scheme of symmetric and asymmetric |
| | encryption is used to protect the serialized |
| | CapUseReq. As a result, when using this flag, |
| | the GUID of the destination agent must also be |
| | supplied. |
| Ping | The CapUseReq exercises all of the orchestration, |
| | routing, and delivery mechanisms which lead to |
| | execution of the request, but the request is |
| | not executed. Thus, this flag provides a mechanism |
| | for the agent application to validate that a capability |
| | still exists. |
| WaitForCapability | If the request cannot be serviced immediately, |
| | it is queued until some later point when it can be |
| | serviced. Specifying the GUID of the peer agent |
| | constrains the current and future servicing of the |
| | request to the specified peer agent. Specifying no |
| | agent GUID indicates that the request can be |
| | serviced anywhere in the P2P network. |
| Migrate | If the capability doesn't exist in the local agent, |
| | the capability is located, its logic brought to the |
| | local agent, and the CapUseReq serviced locally. |
| | If the capability already exists in the local agent, |
| | no performance penalty is paid for passing this flag. |
| | This flag can be combined with Ping to request |
| | migration of a capability without executing any |
| | requests. |

By using these flags, the agent application can execute a request for a capability outside the local agent without knowledge of where the capability is located or whether the capability is available immediately or not. By attaching the WaitForCapability and reliable flags to the request, if the desired capability is not available immediately, the request is queued and passed reliably to the destination agent when the capability becomes available to the local agent.

The following example indicates how the CapUseReq can be used to invoke the capability in a synchronous or asynchronous fashion:

```
// Instantiate CapUseReq class and invoke Capability
{
  WorkerCapUseReq capUseReq = new WorkerCapUseReq
  (workerNumber);
// Synchronous invocation
  WorkerResponse resp = capUseReq.Exec( );
// Asynchronous invocation
  CapUseReq.BeginExec(
    SAMI. CapUseReqExecFlags.Default,
    System.Guid.Empty,
    new System.AsyncCallback (this.WorkerHasFinished),
    workerNumber);
}
// Delegate invoked when asynchronous Capability request finishes
public void WorkerHasFinished ( System.IAsyncResult ar)
{
  SAMI.CapUseReq capUseReq = ar.AsyncState as SAMI.CapUseReq;
  try
  {
    WorkerResponse resp = (WorkerResponse)capUseReq.EndExec
    ( ar );
  }
  catch (SAMI.Exception. SAMI Exception kex )
  {
    // Error handling
  }
  // Use WorkerResponse object
}
```

Event handling component 130 processes events associated with application services. For example, a file is published by issuing a publishing request (e.g., FilePublishingRequest). Published files are maintained by the agent, meaning that the published files are automatically re-published when the agent restarts. In an exemplary embodiment, retrieval is performed using a FileGetter object that supports an asynchronous retrieval model, that sends callbacks to indicate progress, that allows files to be retrieved ‘in order’, that allows access to the data in the file before the entire file has arrived, and that copies the data to a specified location.

When content is published the agent creates an event for that file. When a new subscription is received for the event, an event notification is sent to the new subscriber which contains the list of file segments that the agent possesses. The initial publisher of the file possesses all of the file segments of the file. The file publisher responds to requests by returning responses containing the requested file segments. In an exemplary embodiment, the file publisher uses a status callback mechanism to determine when the message is sent from the subscribing agent and only allows a definable number of file segments to be sent, but not received at a given time. A request to cancel a request for a file segment may be accepted at the file publisher.

When a FileGetter object is activated, it sends a ‘get file’ request to the local agent. The computing device begins the retrieval process by querying orchestration component 132 to identify all instances of the event representing the file and subscribing to each of the identified events. The computing device also registers with orchestration component 132 to be informed of new instances of the event that appear in the network as other peers begin to receive the same file. When a new instance of the event appears, the agent subscribes to the event to determine what file segments are available at the peer agent.

Each event responds with the list of file segments that the peer agent currently possesses. The FileGetter object begins requesting blocks of the file segments. In an exemplary embodiment the block size is 64 kbytes. In an exemplary embodiment, the FileGetter object may request the blocks in random order or in the order that the file is organized. When the first file segment is received the FileGetter object publishes the file. When all of the file segments are received, the event is sent to other subscribers to notify them of the completion. In an exemplary embodiment, the FileGetter object may attempt to always have a first number of requests pending on each of a second number of peer agents. By default the FileGetter object may request blocks in random order, unless the ‘in-order’ flag is set in which case the FileGetter object may attempt to retrieve the file segments in order. If progress feedback was requested, the FileGetter object may subscribe to this event and provide appropriate feedback based on the number of file segments received. When the number of file segments remaining is less than, for example, the first number of requests times the second number of peer agents, the FileGetter object may request all remaining file segments from all peer agents and send a ‘cancel’ request to all peer agents as the file segments are received.

Because applications built using agent infrastructure 134 are inherently mobile, they can be executed where they can best leverage the network's resources. Orchestration describes interactions between peer agents at the message level, including the business logic and execution order of the interactions. Orchestration component 132 implements location transparency for the servicing of application service requests. When one service makes a request of another service, orchestration component 132 of service infrastructure 112 determines the most appropriate agent to service the request based on the resources required to service the request, based on the resources available both on the computing device and on other peer agent devices, based on the network distance to the peer agent, based on the presence of a service gateway, based on the bandwidth to the peer agent, based on changing communication traffic patterns, etc.

In an exemplary embodiment, the local agent queries if the computing device itself can provide the service. If the computing device can provide the service, the service is performed at the computing device. If the computing device can not provide the service, the local agent sends a request to other peer agents accessible by the computing device. If a plurality of peer agents can provide the service, a random selection of the peer to perform the service may be performed. As known to those skilled in the art, other methods may be used to select the peer agent to perform the service. The selected peer agent is sent the service request. If none of the peer agents can provide the service, the request is forwarded to a service gateway for servicing of the request.

Content distribution component 116 and internet peering component 118 allow the local agent to function in an open-Internet environment in a similar fashion to a local network environment. Content distribution component 116 provides a reduction in server load in scenarios where many peers are behind firewalls, and where UDP-broadcast-based discovery does not work. As a result, agents on the open Internet can connect to each other to facilitate the propagation of content through the network and to reduce bandwidth usage on the server. Exemplary embodiments detect the presence of NATs and co-operate with NATs and firewalls to allow incoming connections. Communication channels are also established between mutually-firewalled peers even without the co-operation of the firewalls.

An exemplary design illustrates content distribution component 116. In general, the exemplary design extends peer discovery to allow arbitrary code that provides additional peer discovery advertisements, and to introduce the idea of ‘peer groups’ as an application-level abstraction that allows agent applications to indicate with which set of peers it would be most advantageous to share content. More specifically, application code on the server generates arbitrary ‘peer group’ names based on appropriate criteria and passes these along to the agent. When the agent requests content, it passes the ‘peer group’ name along. As such, the ‘peer group’ name makes it possible to track the peer groups of which the agent is a part.

A content distribution and Internet peering server can include agent connection information and peer groups. When files are being retrieved, the agent indicates to the peer management server that the appropriate peer group is active. When all downloads are finished, the agent tells the peer management server that the peer group is inactive. The agent stays registered with the peer management server. If network connectivity drops or changes, the agent re-registers with the peer management server. Accordingly, it is possible to track all registered agents, their peer groups, universal resource identifiers (URIs), and the active/inactive status of the agent at the peer management server.

When a new agent registers in a given peer group, its connection information is passed along to all other ‘active’ agents in that peer group. When an agent registers and indicates that it is ‘active’, it is sent the connection information for all other agents currently in that peer group. The server may choose to pass out only subsets of the available peer discovery advertisements, but if so, it provides a mechanism to request additional peer discovery advertisements. When the server detects that agents have gone offline, it removes their entries from its records. The server may choose to push out peer discovery advertisements to inactive peers in cases where the inactive peer is firewalled but has content that other active and non-firewalled peers would benefit from; in this case, the inactive peer could initiate the connection between the two peers.

The design can be implemented at a variety of levels. At a first level, a client can conduct basic discovery on the open Internet. At a more advanced level, the server component is enhanced to detect the presence of NATs between it and a given agent, and it takes this into account when propagating the peer discovery advertisements. At an even more advanced level, agents can use universal plug and play (UPnP) to programmatically create port-forwarding rules on their local Internet gateway device (IGD). A further advanced level includes agents and servers using advanced techniques to set up communication channels between agents without the help of the IGD.

A number of enhancements implement these levels within SAMI 104. For example, SAMI 104 preferably accepts a request containing peer discovery advertisements. The response to this request indicates whether the agent is at its discovery threshold or not. Additionally, discovery preferably tracks failed connection attempts and does not repeat them. ‘Accept connection’ preferably consults the topology strategy in cases where it might refuse an incoming connection. Additionally, network components preferably respect the hierarchy of connection types: if a user makes an explicit request to add a connection that already exists because of discovery, the connection's source is ‘upgraded’ from ‘discovery’ to ‘user’. Still further, the threshold handling is modified such that the connection being replaced is removed after the new connection has been added in case the new connection fails.

In other enhancements, the server receives agent registrations containing peer group names and URIs; the server receives ‘active’ and ‘inactive’ notifications from agents and tracks this information; when new agents arrive in existing peer groups, the server propagates those peer discovery advertisements to other active agents in the peer group; when agents request peer discovery advertisements for a peer group, the server returns peer discovery advertisements; the server may choose to push peer discovery advertisements to inactive peers in cases where the inactive peer is behind a firewall and the active peer is not; if an agent is disconnected, the server removes all state associated with it; and the server returns only subsets of available peer discovery advertisements. If an agent indicates that it is still below its discovery threshold after processing a given batch of peer discovery advertisements, the server sends out another batch.

Internet peering component 118 on the agent tracks all of the peer groups of which the agent is a part and the active/inactive status for each group. ‘Active’ indicates that there is an outstanding retrieval within the peer group; ‘inactive’ indicates that no retrievals are active within the peer group. If the agent becomes part of a new peer group, it requests peer discovery advertisements from the server. The agent registers its URIs and peer group names with the server and keeps the server informed of its active/inactive status. The agent tracks the connectivity to the server and re-registers with the server if the connectivity is dropped. Preferably, the agent considers its current neighbors first, neighbors arriving as a result of new peer discovery advertisements second, and the server last.

To achieve a more advanced level of implementation, the IP addresses in incoming peer discovery advertisements can be compared to the perceived remote IP address from the server's point of view, to determine whether there's a NAT between the agent and the server. If so, the peer discovery advertisement should not be propagated because incoming connection attempts most likely will be refused. In a further advancement, an application discovery component on an agent can discover the presence of a local IGD, learn the external IP address of the IGD, and negotiate a port-forwarding rule with it. If the agent is successful, this information can be used to build a peer discovery advertisement for itself using the external IP address and port. The agent passes the peer discovery advertisement on to the peer management server. The session initiation protocol can also be used.

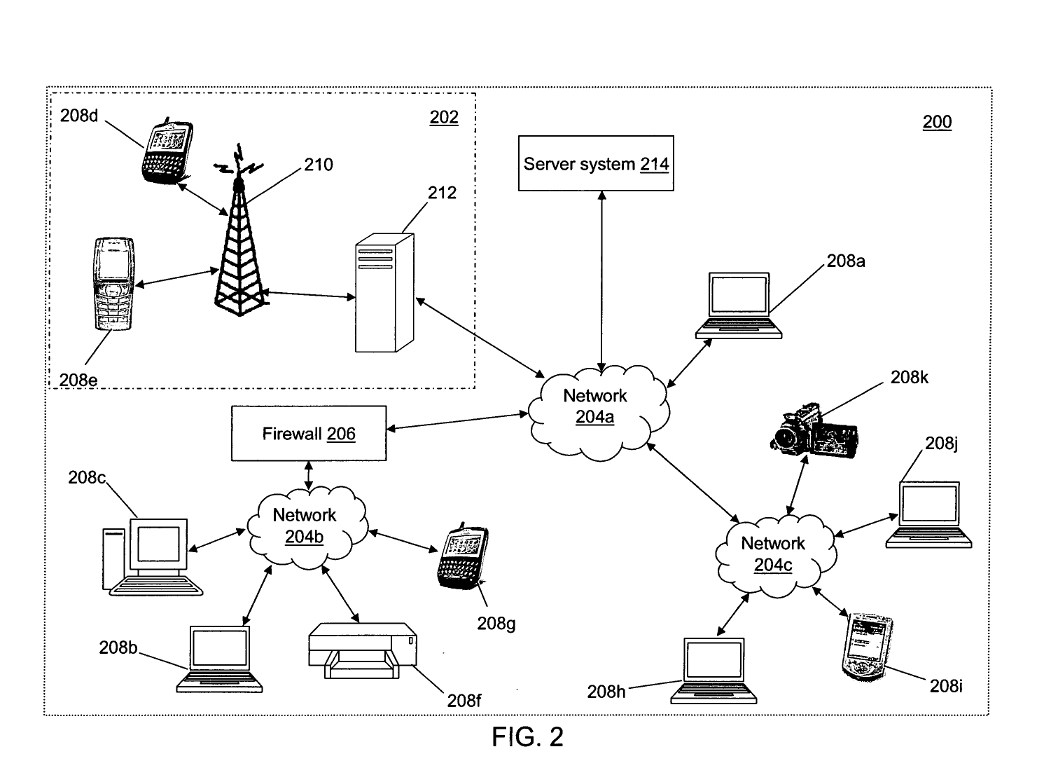

With reference to FIG. 2, a system diagram of a P2P network 200 in accordance with an exemplary embodiment is shown. P2P network 200 can include a server system 214, one or more networks 204, a firewall 206, a cellular network 202, and a plurality of computing devices 208. The one or more networks 204 for example include a first network 204a, a second network 204b, and a third network 204c. There may be fewer or additional networks in P2P network 200 as known to those skilled in the art both now and in the future. Cellular network 202 can include a network server 212, a base station 210, and a plurality of devices. For example, cellular network 202 includes an integrated messaging device 208d, such as a Blackberry device manufactured by Research in Motion, and a cellular telephone 208e. Network server 212 allows communication between the devices 208d, 208e and first network 204a. In the cellular network 202, devices send and receive signals through base station 210.

The P2P network can include any number and type of computing devices that may be organized into subnets. Any of the subnets or devices may be separated by a firewall. Exemplary P2P network 200 includes a broad network 204a such as the Internet, second network 204b accessible through firewall 206, and third network 204c. Exemplary computing devices 208a-208k include computers of any form factor such as laptops 208a, 208b, 208h, 208j, a desktop 208c, an integrated messaging device 208g, a personal digital assistant 2081, etc. Exemplary computing devices also include intelligent appliances and peripherals such as printer 208f and video camera 208k. P2P network 200 may include additional types of devices. Computing devices 208a-208k communicate using various transmission media that may be wired or wireless. Each device of the computing devices 208a-208k hosts at least a portion of software architecture 208 and instantiates at least one agent.

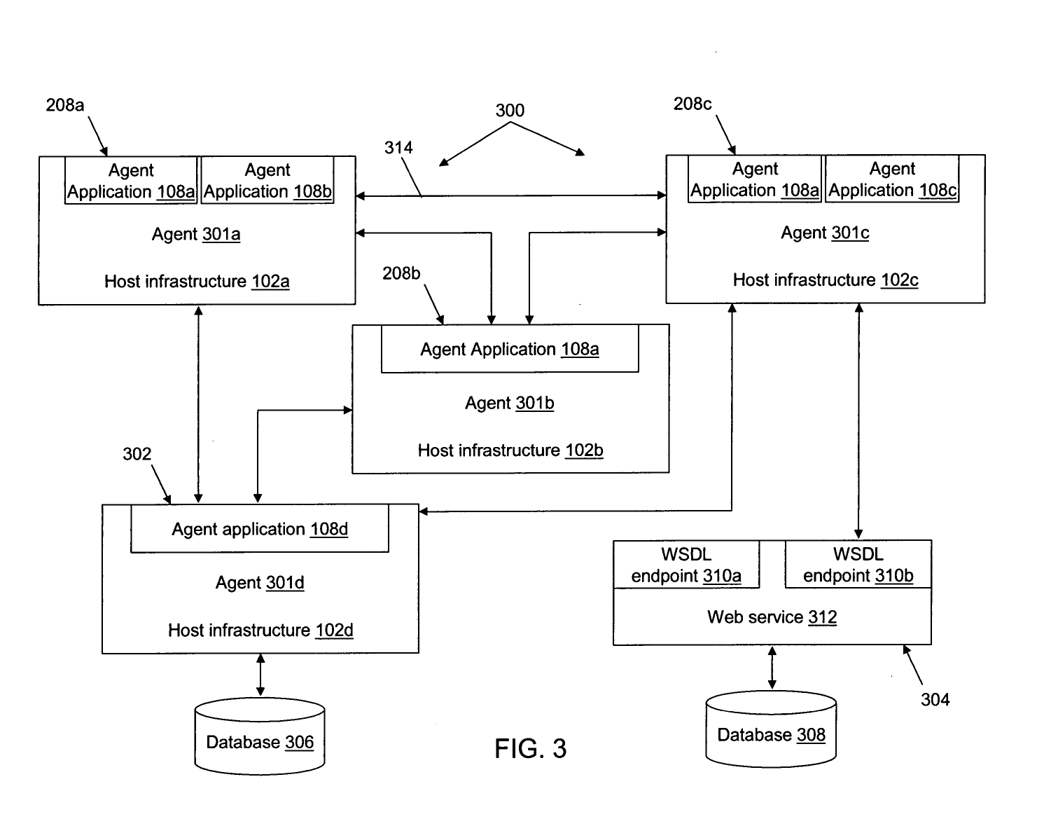

With reference to FIG. 3, a network 300 is shown. Network 300 can include a first device 208a, a second device 208b, a third device 208c, a peer management server 302, and a web server 304. First device 208a includes first agent application 108a, second agent application 108b, a first agent 301a, and a first host infrastructure 102a. Second device 208b includes first agent application 108a, a second agent 301b, and a second host infrastructure 102b. The third device 208c includes first agent application 108a, third agent application 108c, a third agent 301c, and a third host infrastructure 102c. Peer management server 302 includes a fourth agent application 108d, a fourth agent 301d, and a fourth host infrastructure 102d. First agent 301a, second agent 301b, third agent 1301c, and fourth agent 301d are instances of agent infrastructure 134 instantiated at devices 208a, 208b, 208c, and 302, respectively. Each device can include a plurality of agents.

Host infrastructures 102a, 102b, 102c, 102d may be the same or different. Fourth agent application 108d may provide similar functionality, for example, to first agent application 108a, but incorporate control processing for coordinating functionality at devices 208a, 208b, and 208c. In another exemplary embodiment, fourth agent application 108d may be identical, for example, to first agent application 108a, but because peer management server 302 has identified itself as a server relative to devices 208a, 208b, and 208c, peer management server 302 executes distinct logic within fourth agent application 108d to perform the functionality of a server or “super peer.” For example, peer management server 302 may have sufficient processing speed and memory to perform the functions of a server or “super peer.” Peer management server 302 includes or can access peer management database 306 either through a direct connection or through a network.

Web server 304 includes a web service 312 and one or more WSDL endpoints 310. For example, web server 304 includes a first WSDL endpoint 310a and a second WSDL endpoint 310b. Web server 304 includes or can access database 308 either through a direct connection or through a network. In another embodiment, network 300 does not include web server 304. First agent 301a, second agent 301b, third agent 301c, fourth agent 301d, and web server 304 communicate using message transport component 114 of agent infrastructure 134. Among other alternatives, server system 214 may be implemented as web server 304 and/or peer management server 302.

In an exemplary embodiment, peer management server 302 can coordinate the secure and reliable messaging communications between agents 301 installed at devices 208a, 208b, and 208c, peer management server 302 in network 300. Because each agent 301a, 301b, 301c, 301d has the same store and forward mechanism, peer management server 302 can be used as a temporary storage point for an agent that is not currently connected to network 300. When the agent reconnects to network 300, stored messages are read from peer management server 302 and sent to the newly connected agent. In another embodiment, network 300 may include more than one peer management server 302. In another embodiment, network 300 does not include peer management server 302. Peer management server 302 may be implemented as a redundant array of independent disks, using a scalable network attached storage device, etc.

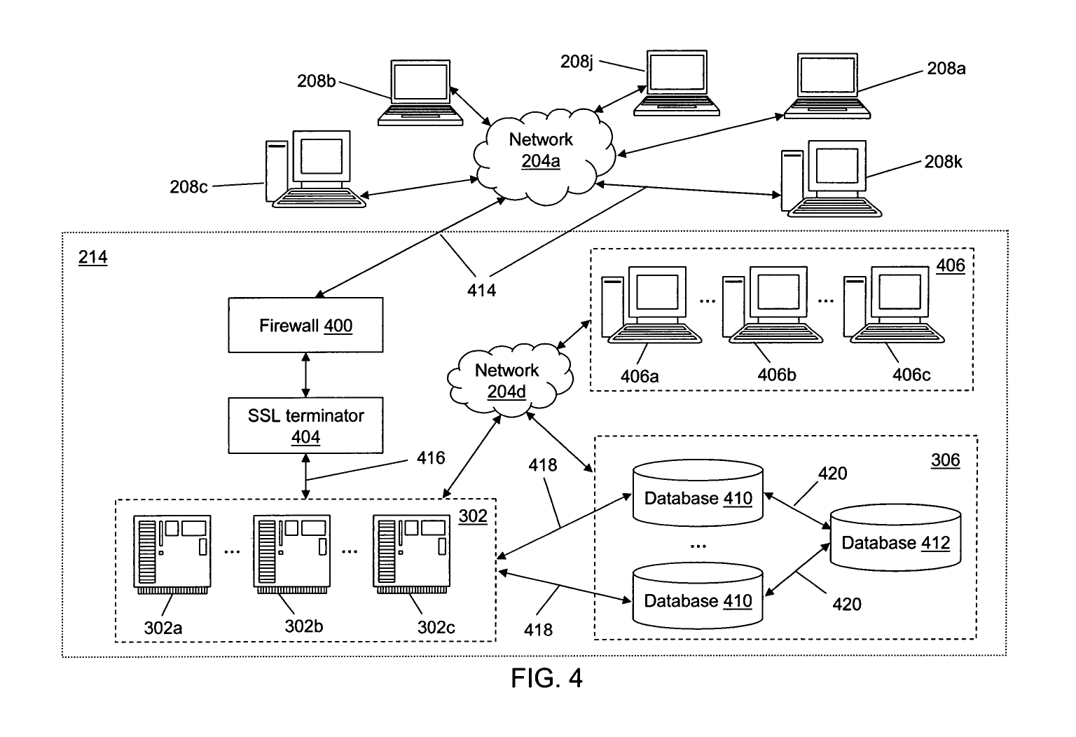

With reference to FIG. 4, server system 214 can include a second firewall 400, a secure sockets layer (SSL) terminator 404, peer management server 302, peer management database 306, a fourth network 204d, and a management console 406. SSL terminator 404 manages the security of message transmissions between devices 208 and server system 214. Other protocols may be used as known to those skilled in the art both now and in the future. Thus, message transmissions 414 between computing devices 208 and from network 204a to server system 214 may be transmitted using HTTP over SSL (HTTPS) until they reach SSL terminator 404. Second message transmissions 416 between SSL terminator 404 and peer management server 302 may be transmitted using HTTP. Third message transmissions 418 between peer management server 302 and peer management database 306 may be transmitted using TCP/IP. Peer management server 302 may include a plurality of peer management servers 302a, 302b, 302c. Management console 406 may include a plurality of management consoles 406a, 406b, 406c.

Peer management database 306 may be organized into multiple tiers of databases to improve data management and access. For example, peer management database 306 may include a first database tier 410 and a second database 412. First database tier 410 may include a plurality of databases that communicate with peer management server 302. First database tier 410 may support short running, time sensitive transactions. Second database 412 may support data warehousing and long running, reporting style queries. Fourth message transmissions 420 between first database tier 410 and second database 412 of peer management database 306 may be transmitted using structured query language (SQL) server transaction replication.

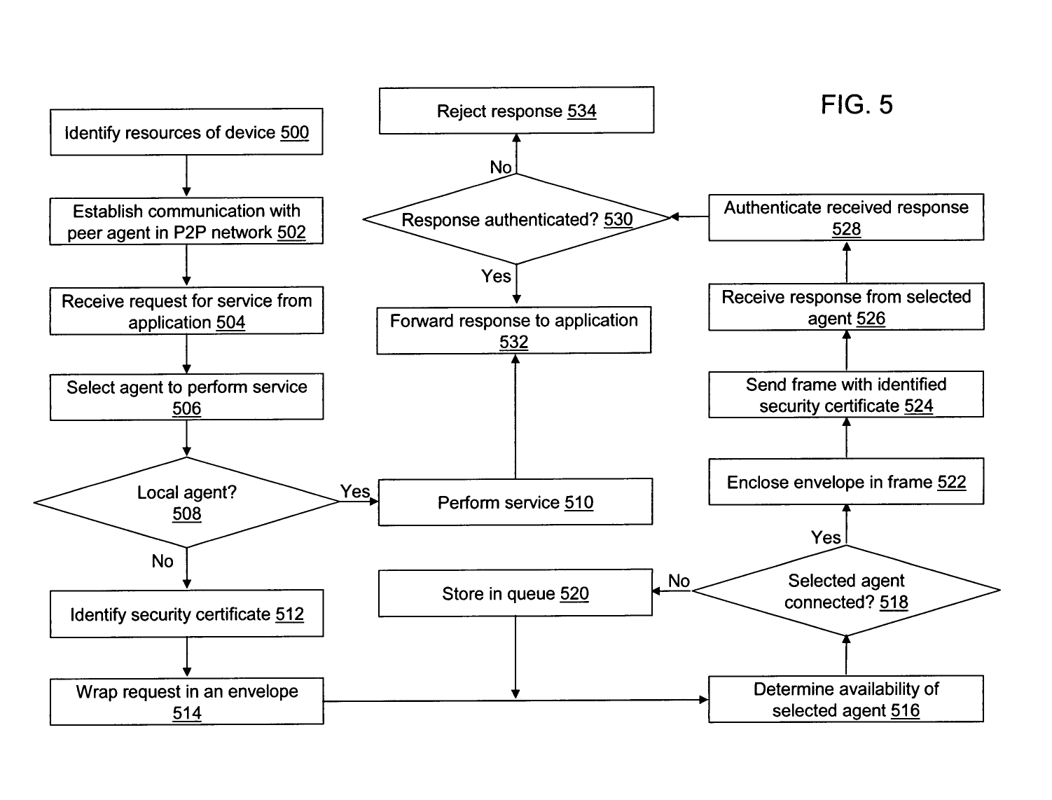

With reference to FIG. 5, exemplary operations performed by first agent 134a instantiated at device 208a are described. Additional, fewer, or different operations may be included depending on the embodiment. In an operation 500, local agent 301a (FIG. 3) of device 208a identifies the resources available at device 208a. Exemplary resources include the random access memory (RAM), the type of RAM, the read only memory (ROM), the processor type, the processing speed, network connection characteristics, applications 108 installed at device 208a, etc. In an operation 502, agent 134a establishes communication with a peer agent in P2P network 300. First agent 301a may establish communication with agents 301b, 301c, and 301d. For example, communication may be initiated with a handshake, which exchanges identity information such as the GUID of each agent 301b, 301c, and 301d. The identified resource information may be transmitted between agents 301a, 301b, 301c, 301d, and/or web server 304.

In an operation 504, first agent 301a receives a request for a service, for example, from first agent application 108a. In an exemplary embodiment, the request may be an instance of a CapUseReq class. In an operation 506, first agent 301a selects a peer agent (such as agents 301b, 301c, and/or 301d) to execute the service. For example, orchestration component 132 of agent infrastructure 134 determines the most appropriate agent 301a, 301b, 301c, and/or 301d to service the request. In an operation 508, a determination is made concerning whether or not the selected agent is local to device 208a. If the selected agent is local to device 208a, the service is performed in an operation 510 and processing continues at operation 532. The application performing the service may be different from first application agent 108a. For example, second agent application 108b may perform the requested service. If the selected agent is not local to device 208a, a security certificate is identified in an operation 512. In an operation 514, the request is wrapped in an envelope with information such as the GUID of first agent 301a and/or the selected agent.

In an operation 516, the availability of the selected agent is determined. In another embodiment, the availability of the agent may be considered when selecting the agent to perform the service (operation 506). For example, a CapUseReq including the ‘Ping’ flag may be sent to validate that the capability still exists at the selected agent. In an operation 518, a determination is made concerning whether or not the selected agent is connected to P2P network 300. If the selected agent is not connected to P2P network 300, in an operation 520, the message may be stored in a store and forward queue of first agent 301a. In another embodiment, the message may be stored at another agent such as fourth agent 301d. Processing continues at operation 516. In another embodiment, processing may continue at operation 518. For example, when the selected agent reconnects, a message may be sent indicating that the selected agent has reconnected.

If the selected agent is connected to P2P network 300, in an operation 522, the envelope is enclosed in a frame. In an operation 524, the frame is sent with the identified security certificate to the selected agent. For example, if the selected agent is third agent 301c instantiated at third device 208c, the message may be sent using a bi-directional TCP connection to third device 208c. The bi-directional TCP connection can traverse firewall 206 and can require multiple hops using other peer devices if necessary.

The selected agent receives the request and authenticates the request using the security certificate. If the request is authenticated, the selected agent performs the service by executing the request. For example, third agent application 108c at third device 208c may execute the request. Alternatively, first agent application 108a at third device 102c may execute the request. The selected agent prepares a response including a security certificate for transmission to the requesting agent. For example, third agent 301c prepares a response to first agent 301a. The selected agent sends the prepared response to the requesting agent. For example, third agent 301c sends the prepared response to first agent 301a.

In an operation 526, first agent 301a receives the response from the selected agent. In an operation 528, first agent 301a authenticates the response using the enclosed security certificate. In an operation 530, a determination is made concerning whether or not the response is authenticated. If the response is authenticated, in operation 532, the response is forwarded to first agent application 108a. If the response is not authenticated, in an operation 534, the response is rejected.

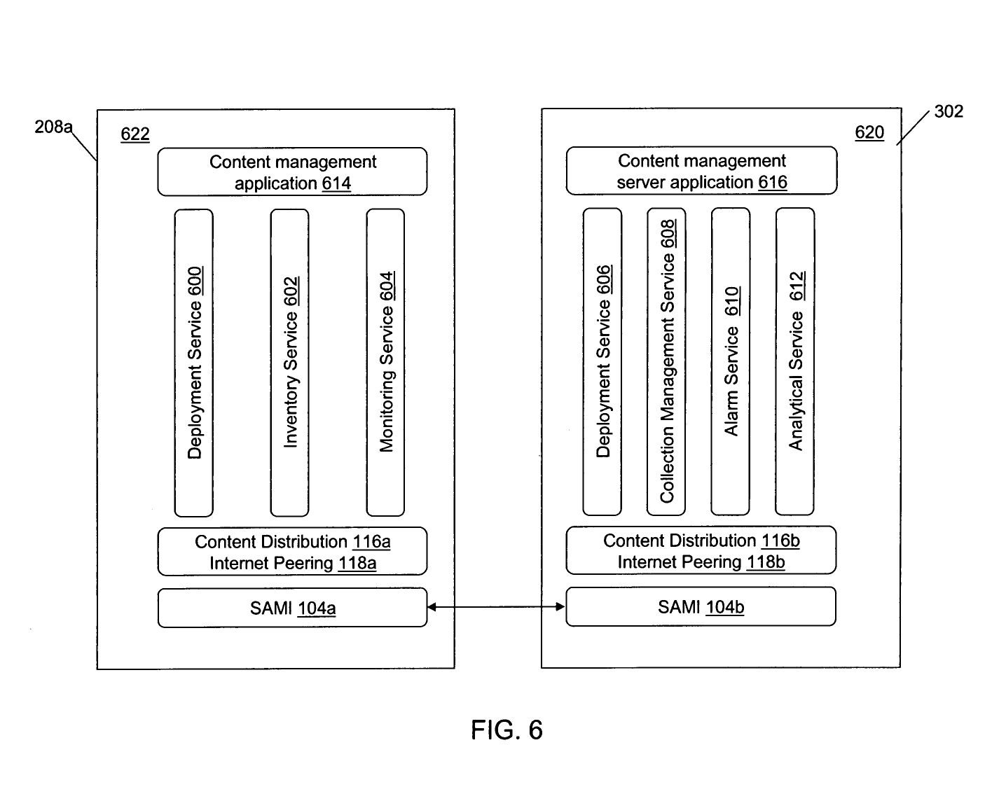

With reference to FIG. 6, in an exemplary utilization of agent infrastructure 134, peer management server 302 can act as an integration point for an enterprise management system to install, monitor, update, and uninstall applications at devices 208a, 208b, 208c using a content management server agent infrastructure 620 installed at peer management server 302. Content management server agent infrastructure 620 may include SAMI 104b, content distribution component 116b, Internet peering component 118b, a first collection of services, and a content management server application 616. In this exemplary embodiment, fourth agent application 108d includes content management server application 616 that includes the first collection of services that implement server side management capabilities. Fourth agent 301d is an instance of content management server agent infrastructure 620.

The first collection of services may include a deployment service 606, a collection management service 608, an alarm service 610, and an analytical service 612. Deployment service 606 may install, update, and/or uninstall one or more agent with a version of first application 108a. Collection management service 608 may support the install, update, and/or uninstall of first agent application 108a deployed to a collection of agents. Alarm service 610 may identify and report problems associated with one or more agent. Analytical service 612 may identify and save information to peer management database 306 about devices 208a, 208b, 208c in network 300 and the usage of first application 108a at each device. The information may include which devices 208a, 208b, 208c are available in the network 300, details relating to the host infrastructures 102a, 102b, 102c, what agent applications and/or other applications are installed at devices 208a, 208b, 208c, the components of these applications and their version numbers, etc.

With reference to FIG. 6, in a second exemplary utilization of agent infrastructure 134, first device 208a may be computing device 208a which is managed by peer management server 302 using a content management agent infrastructure 622 installed at computing device 208a. Content management agent infrastructure 622 may include SAMI 104a, content distribution component 116a, Internet peering component 118a, a second collection of services, and a content management application 614. In this exemplary embodiment, first agent application 108a includes content management application 614 that includes the second collection of services that implement client side management capabilities. The second collection of services may include a deployment service 600, an inventory service 602, and a monitoring service 604. Deployment service 600 may install, update, and/or uninstall a version of an application received from peer management server 302. Inventory service 602 may identify and report, for example, the resources available at device 208a to peer management server 302. Monitoring service 604 may identify and report, for example, the status of device 208a to peer management server 302.

Peer management server 302 may store information about the agent applications 108 at each device 208a, 208b, 208c in peer management database 306. Peer management database 306 may also be the repository for application usage statistics and aggregated logging information. Additionally, peer management database 306 may access a security certificate service for a security certificate of an agent executing at one of the devices 208a, 208b, 208c.

In an exemplary embodiment, if first agent 301a loses and regains connectivity with peer management server 302, Internet peering component 118 notices the drop in connectivity and re-registers the URIs and the peer groups of first agent 301a with peer management server 302. If first agent 301a starts installing an application because of an install request, Internet peering component 118 passes the peer group name to peer management server 302 and sets the status of first agent 301a to ‘active’. If first agent 301a is not already part of this peer group, Internet peering component 118 notifies peer management server 302, and peer management server 302 responds with peer discovery advertisements for that peer group. If new remote agents begin installing the application, peer management server 302 passes new URIs to all active agents in the peer group. If first agent 301a finishes installing the application, first agent 301a indicates to peer management server 302 that it is now inactive, and peer management server 302 does not send any new peer discovery advertisements. If the list of URIs for first agent 301a changes, first agent 301a notifies peer management server 302. Peer management server 302 sends these new URIs to all active agents in the notifying agent's peer groups.

In an installation scenario, peer management server 302 sends an install request to first agent 301a, which may include an application identifier. First agent 301a interacts with content distribution component 116b and internet peering component 118b of peer management server 302. Content management application 614 may send a request for content through deployment service 600 and content distribution component 116a without a hint as to the sending peer management server 302. Content management application 614 may also send a request to internet peering component 118a to join a peer group. In response, Internet peering component 118a may send a join peer group request to Internet peering component 118b of peer management server 302.

In an alternative embodiment, orchestration component 132 can be used to discover super-peers. Internet peering component 118a may request a list of peer discover advertisements from the SAMI API 134 and determine whether more are needed. Internet peering component 118b may simultaneously push peer discover advertisements to Internet peering component 118a at the discretion of peer management server 302 or as new agents join the peer group. If there are not enough discover advertisements and the requested content cannot be acquired, content management application 614 may resend a request for content to content distribution component 116a with a hint as to the sending peer management server 302. At some point, Internet peering component 118a tells Internet peering component 118b that it is inactive (e.g., finished acquiring content).

In an uninstall scenario, peer management server 302 sends an uninstall request to first agent 301a. First agent 301a interacts with content distribution component 116b and Internet peering component 118b of peer management server 302. Content management application 614 may instruct Internet peering component 118a to leave the peer group. Content management application 614 may instruct content distribution component 116a to unpublish all of its content. Internet peering component 118a may instruct Internet peering component 118b that it is leaving the peer group.

In a reconnect scenario, first agent 301a may instruct Internet peering component 118a which applications are installed and the peer groups to join. Internet peering component 118a may instruct Internet peering component 118b of peer management server 302 which peer groups it belongs to along with its active status. In a disconnect scenario, which may occur when first agent 301a shuts down or loses connectivity with peer management server 302, Internet peering component 118b of peer management server 302 removes first agent 301a from all peer groups.

Management console 406 may include an administration interface for installing, monitoring, updating, and uninstalling applications at agent devices. In an exemplary embodiment, the administration interface includes a Microsoft .NET Windows Forms application that enables administrators to manage applications on any device where agent 301d is instantiated. The administration interface provides a drag-and-drop graphical user interface (GUI) for an administrator of peer management server 302. Alternatively, a command line interface may be utilized. Management console 406 may be directly connected to peer management server 302 or may connect with peer management server 302 using, for example, fourth network 204d. Thus, management console 406 and peer management server 302 may be integrated in the same device or implemented in separate devices. Data retrieval and reporting from peer management server 302 provides information such as the number of applications, application usage, capability models for each managed agent, etc.

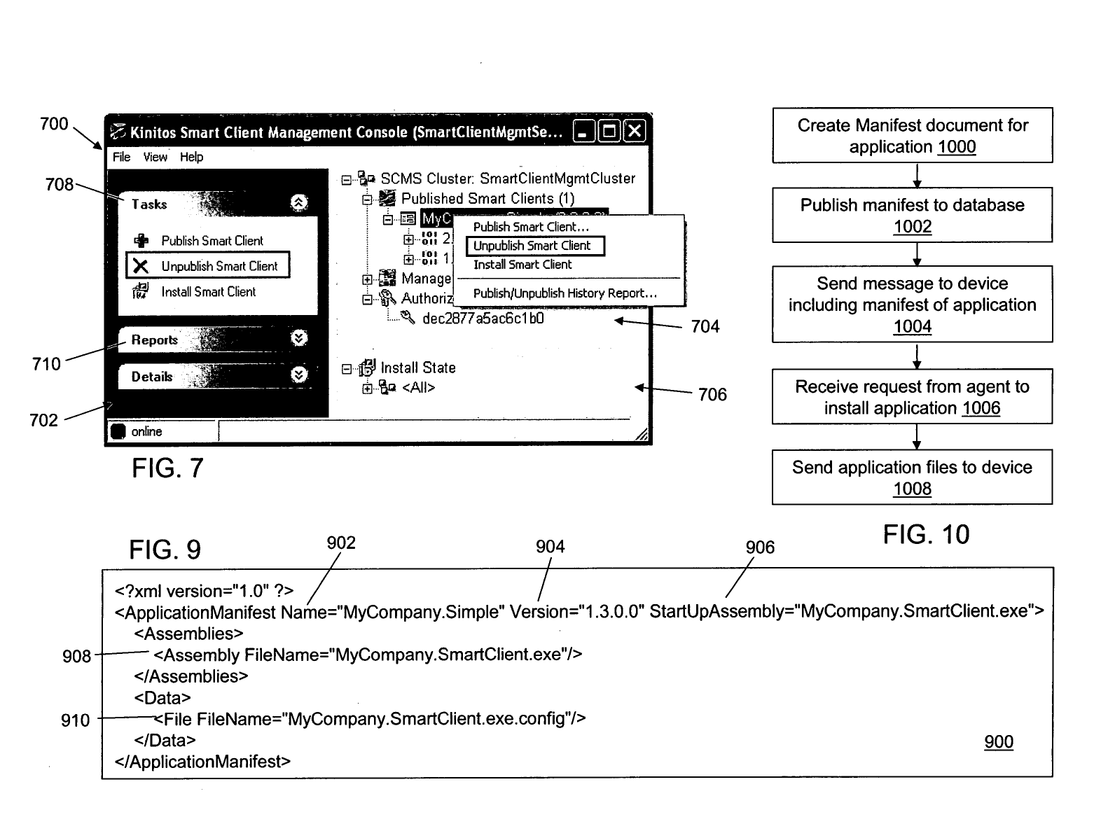

With reference to FIG. 7, an exemplary first display 700 for the administration interface is shown. The administration interface may include additional or fewer GUI displays than discussed herein. An application can be published, unpublished, or installed using first display 700. First display 700 includes a context panel 702, a cluster panel 704, and an install state panel 706. Context panel 702 allows the administrators to select from tasks listed in a task area 708 and to create reports listed in a report tab 710. Cluster panel 704 displays applications published to peer management server 302, agents included in the server cluster, and any public key tokens that have been authorized by the administrator. Install state panel 706 displays information related to the installation status of each agent.

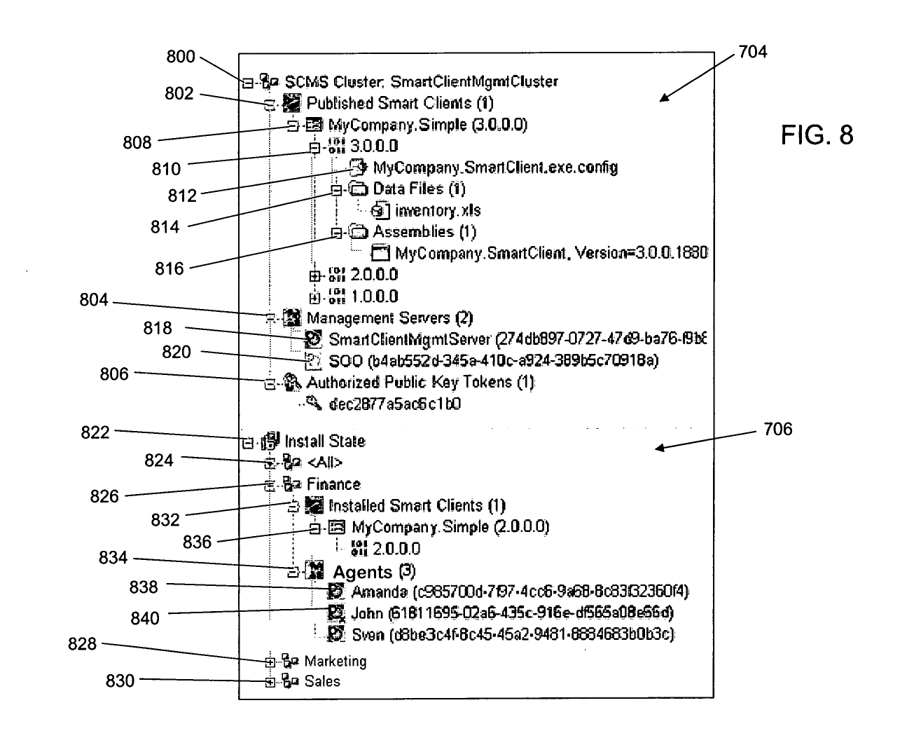

With reference to FIG. 8, additional details associated with cluster panel 704 and with install state panel 706 are provided. Cluster panel 704 includes a hierarchy of information presented to the administrator to monitor a cluster of applications. A root node 800 of the hierarchy of the cluster can be opened to include a published application node 802, a management server node 804, and an authorized public key token node 806. Published application node 802 includes an application version node 808. Application version node 808 contains a node for each installed version of the application. For example, as shown with reference to FIG. 3, three versions of the “MyCompany” application have been installed. A version node 810 indicates that it is version 3.0.0.0. Nodes below version node 810 include a configuration file node 812, a data file node 814, and an assembly node 816. Configuration file node 812 indicates the configuration file for version 3 of the application “MyCompany”. Data file node 814 includes a list of data files associated with version 3 of the application “MyCompany”. Assembly node 816 includes a list of assemblies associated with version 3 of the application “MyCompany”. Management server node 804 indicates a deployed runtime node 818 and an active server runtime 820.

Install state panel 706 displays collections of agents instantiated at computing devices 208. Agents are managed using collections, which organize the agents into groups. A collection may represent a geographic group of agents (e.g. West Coast), a functional group of agents (e.g., marketing), a certain deployment of content (all agents receiving content A), etc. Collections organize the agents and the means by which applications are installed to agents. In an exemplary embodiment, an application is not installed to specific agents, but instead to a collection. For each collection, any application installed to that collection and the agents that are members of that collection are displayed. With reference to FIG. 8, install state panel 706 includes a hierarchy of information presented to the administrator to monitor the install state of agents. Install state root node 822 can be opened to display a series of collection nodes: an “All” collection node 824, a “Finance” collection node 826, a “Marketing” collection node 828, and a “Sales” collection node 830. “All” collection node 824 is created by default and includes all of the agents that are defined in peer management database 306. Opening a collection node displays an installed node 832 and an agent node 834. Opening installed node 832 displays a version node 836. Opening agent node 834 displays the agents managed by peer management server 302. Icons adjacent to the agent name indicate whether the agent is online (accessible using a network) or offline (not accessible using a network). For example, agent “Amanda” as indicated by a first icon 838 is online and agent “John” as indicated by a second icon 840 is offline as indicated by the ‘X’ added to the icon.

FIG. 9 illustrates computer code constituting an application manifest 900 which describes an application. In an exemplary embodiment, application manifest 900 is an XML file that includes an application name 902, an application version number 904, a startup application component 906, one or more .NET assemblies 908, and one or more data filenames 910 associated with the application. The manifest 900 is used to publish and to deploy an application indicated by application name 902 and application version number 904. In an exemplary embodiment, the one or more .NET assemblies 908 are comprised of strongly named assemblies or delay-signed assemblies, where the one or more .NET assemblies 908 have been added to the appropriate skip verification lists. A strongly-named assembly is one that has been signed with a public and private key pair. The one or more data filenames 910 may be images or other resources that require installation with the application, may define installation options (e.g. start menu shortcuts, etc.), and/or may define runtime characteristics for that application.

Publishing the application may be accomplished by dragging and dropping application manifest 900 to cluster panel 704. Alternatively, a COM interface, a shell, or a .NET programmable API can support publishing of the application. Once published, the application can be deployed to all or a specific subset of agents defined by a collection. The application is deployed immediately to the agents at computing devices 208 associated with the collection with propagation of the necessary data files P2P using SAMI 104, content distribution component 116, and Internet peering component 118. An administrator can view reports to determine which agents have not yet received the application or which agents encountered a problem caching the application locally. Upgrading the application follows the same procedure.

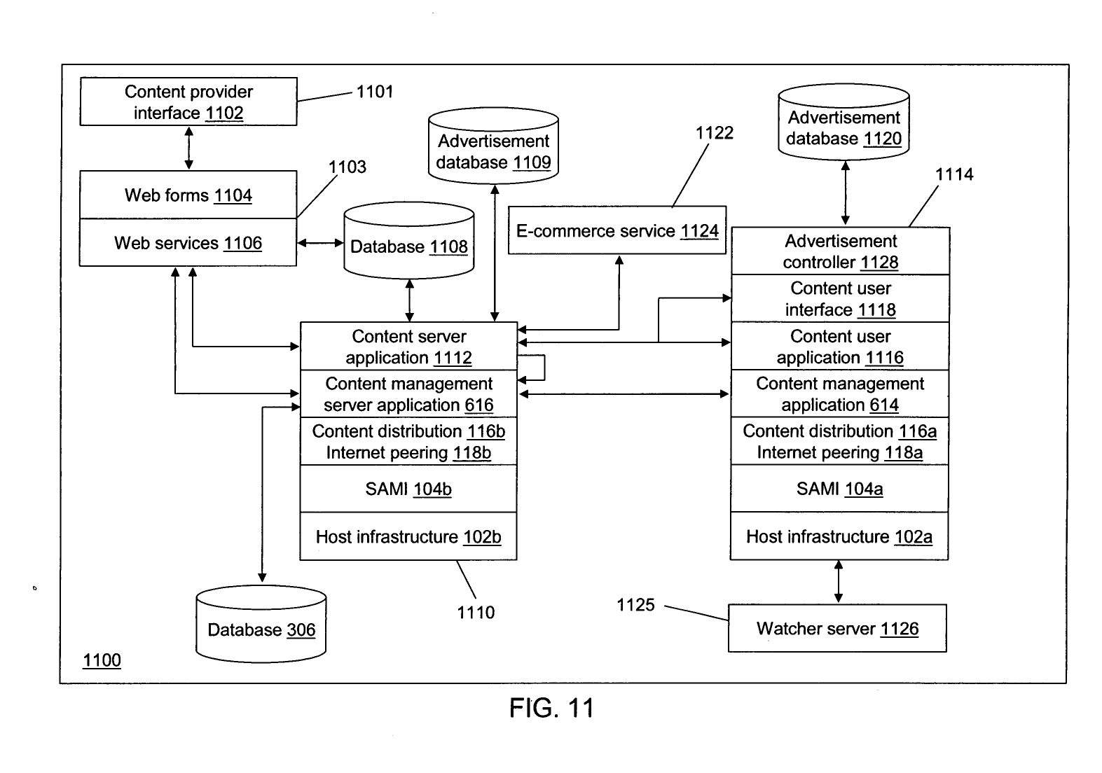

FIG. 10 illustrates operations performed in an exemplary application publication process. Additional, fewer, or different operations may be included depending on the embodiment. In an operation 1000, manifest document 900 is created for the application. In an operation 1002, manifest document 900 is published to peer management database 306. In an alternative embodiment, manifest document 900 is not published to peer management database 306. In an operation 1004, a message that includes manifest document 900 is sent to each computing device in the collection. In an operation 1006, a request is received from the agent instantiated at the computing devices to install the application. In an operation 1008, the application files are sent to the agent devices, for example, using P2P network 300.

In an exemplary embodiment, the management functionality is enabled in the application by adding an assembly-level attribute of the form [assembly: SAMIAttribute(“application-identifier”)] where the “application-identifier” is application name 902. The application can be maintained using fourth agent 301d running at peer management server 302, which notifies each agent in a collection that is hosting an instance of the managed application that an upgrade is available. The agent receiving the notification may locate the closest available agent that can provide the application upgrade and retrieve the upgrade from that agent. If a nearby agent has the new application assembly and the security policy permits it, the application upgrade is retrieved from the nearby agent instead of peer management server 302 which reduces the load on peer management server 302 and permits upgrades even while peer management server 302 is unavailable.

When finished, the agent notifies fourth agent 301d that it has completed the application upgrade. Throughout the upgrade, events are provided that an application can subscribe to in order to be notified of the start, progress, and completion of the application upgrade. Because the upgrade is deployed side-by-side with previous versions of the application, a system administrator can also initiate a rollback to a previous version of the application from peer management server 302. A user at the computing device may also initiate a rollback, if permitted by the application versioning policy defined by the system administrator.

With reference to FIG. 11, a content distribution system 1100 is provided. Content distribution system 1100 receives content from a content provider, makes the content available to users, and delivers the content to users. Content distribution system 1100 may include a content provider device 1101, a content maintenance device 1103, a content server device 1110, a content consumer device 1114, an e-commerce service device 1122, and a watcher server device 1125. In general, the devices of content distribution system 1100 may be connected using one or more network.

Content provider device 1101 includes a content provider interface 1102 which, for example, may be provided by a web browser application interfacing with a web server at content maintenance device 1103. Content provider device 1101 may communicate with the web server at content maintenance device 1103 using a network. Using content provider interface 1102, a content provider can store content on a content database 1108 accessible by content maintenance device 1103 so that a consumer can access the stored content. The content includes, but is not limited to video files, games, advertisements, audio files, software applications, etc.

Content maintenance device 1103 may include a web forms component 1104 and a web services component 1106. In an exemplary embodiment, web forms component 1104 is implemented as an application service provider (ASP).Net forms component. In an exemplary embodiment, web services component 1106 is implemented as an ASP .Net service component. Web forms component 1104 provides information to the content provider using content provider interface 1102 that allows the content provider to store content onto content database 1108. Content maintenance device 1103 may communicate with content database 1108 directly or over a network. Content database 1108 can be a standard SQL server database. Content maintenance device 1103 may comprise HTTP servers, a domain controller, application servers, and/or database servers implemented in the same or different devices.

Content server device 1110 controls the interaction between content maintenance device 1103 and content consumer device 1114. In another exemplary utilization of agent infrastructure 134, content server device 1110 may include a host infrastructure 102b, SAMI 104b, content distribution component 116b, Internet peering component 118b, content management server application 616 (and its associated services), and a content server application 1112. Content server device 1110 communicates with peer management database 306, content database 1108, and a first advertisement database 1109 directly or through a network. Peer management database 306, content database 1108, and first advertisement database 1109 may be implemented in the same or different devices.

First advertisement database 1109 may store advertisements in the form of various media such as a text file, an audio file, a video file, etc. for presentation to a consumer. Content server application 1112 performs operations associated with the provision of access to the content stored by the content provider and/or the advertisements. A fifth agent instantiated at content server device 1110 may be an instance of host infrastructure 102b, SAMI 104b, content distribution component 116b, Internet peering component 118b, content management server application 616 (and its associated services), and content server application 1112. Alternatively, a fifth agent instantiated at content server device 1110 may be an instance of host infrastructure 102b, SAMI 104b, content distribution component 116b, Internet peering component 118b, and content server application 1112; while fourth agent 301d also may be instantiated at content server device 1110 to interact with the fifth agent.

Content consumer device 1114 allows a user to access some or all of the content stored in content database 1108 and in first advertisement database 1109. Content consumer device 1114 may include host infrastructure 102a, SAMI 104a, content distribution component 116a, Internet peering component 118a, content management application 614 (and its associated services), a content user application 1116, a content user interface 1118, and an advertisement controller 1128. Content consumer device 1114 communicates with a second advertisement database 1120 directly. Thus, second advertisement database 1120 is accessible from content consumer device 1114 even when content consumer device 1114 does not have connectivity to content server device 1110. A user accesses content using content user interface 1118 which interacts with content user application 1116 to locate and to access content on content databases 1108, first advertisement database 1109, and/or second advertisement database 1120. Content user interface 1118 may interact with content user application 1116 using SOAP/HTTP and/or HTML/HTTP.

A sixth agent instantiated at content consumer device 1114 may be an instance of host infrastructure 102a, SAMI 104a, content distribution component 116a, Internet peering component 118a, content management application 614 (and its associated services), content user application 1116, content user interface 1118, and advertisement controller 1128. Alternatively, a sixth agent instantiated at content server device 1110 may be an instance of host infrastructure 102a, SAMI 104a, content distribution component 116a, Internet peering component 118a, content user application 1116, content user interface 1118, and/or advertisement controller 1128; while first agent 301a is also instantiated at content server device 1110 to interact with the sixth agent. In still another embodiment, content user application 1116, content user interface 1118, and/or advertisement controller 1128 may be instantiated as separate agents that interact.

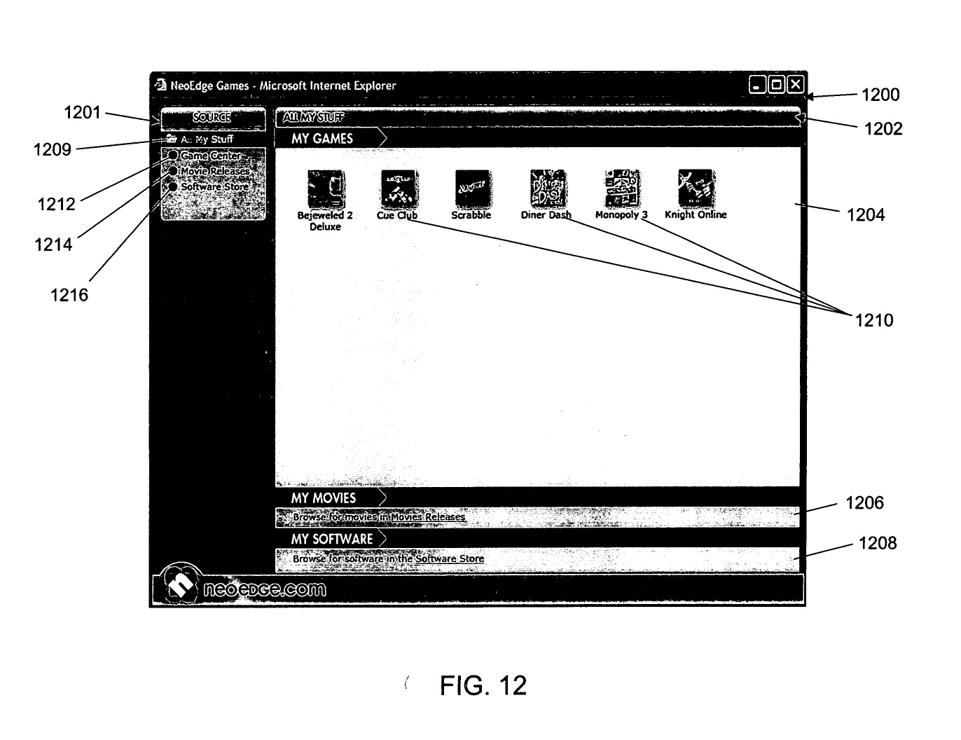

Content consumer device 1114 may further include a browser application and a mail application. Content user interface 1118 may utilize the browser application to present information to the user and to receive selections from the user for accessing and using content. With reference to FIG. 12, an exemplary content user interface display 1200 for content user interface 1118 is shown. Content user interface 1118 may include additional or fewer GUI displays than discussed herein. Content can be accessed using content user interface display 1200. Content user interface display 1200 includes a content summary panel 1201 and a content selection panel 1202. Content summary panel 1201 may include a first menu item 1209, a second menu item 1212, a third menu item 1214, and a fourth menu item 1216. In the exemplary embodiment of FIG. 12, selection by the user of first menu item 1209 causes content selection panel 1202 to display all games installed at content consumer device 1114 in a first display window 1204, all movies installed at content consumer device 1114 in a second display window 1206, and all software installed at content consumer device 1114 in a third display window 1208. For example, first display window 1204 includes one or more icons 1210 that indicate a game.

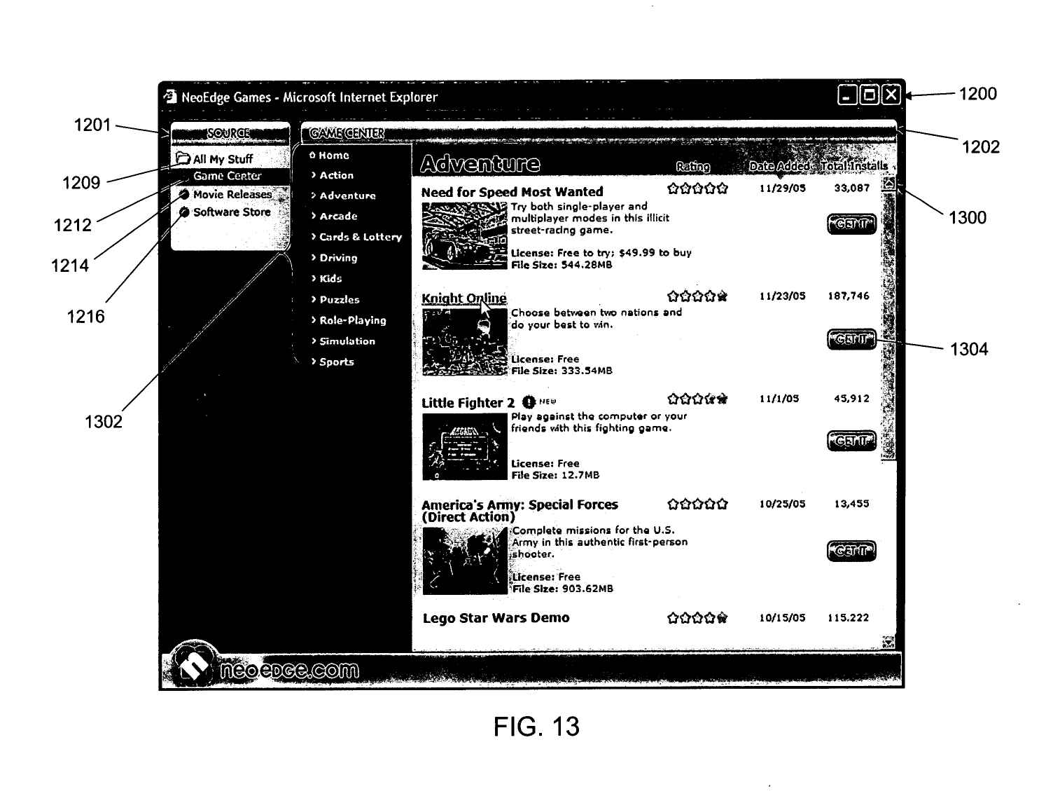

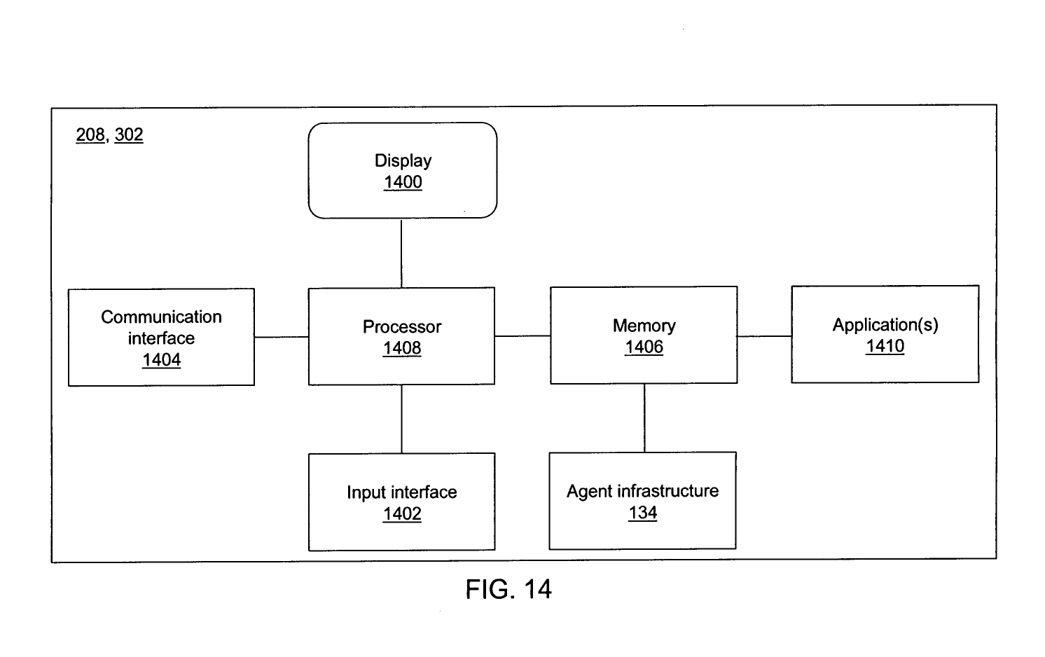

With reference to FIG. 13, selection by the user of second menu item 1212 causes content selection panel 1202 to display available games in a game interface 1300. In the exemplary embodiment of FIG. 13, the available games are organized in a summary list 1302 by category. Exemplary categories include, ‘Action,’ ‘Adventure,’ ‘Arcade,’ ‘Cards & Lottery,’ ‘Driving,’ ‘Kids,’ ‘Puzzles,’ ‘Role-Playing,’ ‘Simulation,’ and ‘Sports.’ The user may select a game for installation using a button 1304. In some cases, the game (content) may be free. In this case, the installation may begin immediately. A request is sent from content user application 1118 to content server application 1112 for the selected content. Alternatively, the game (content) may require payment. Selection of button 1304 may cause content user interface 1118 to present one or more payment interface as known to those skilled in the art both now and in the future.

A request is sent from content user application 1118 to content server application 1112 for the selected content. If payment is required, the payment information entered by the user is sent to an e-commerce service 1124 hosted at e-commerce service device 1122 which determines if the payment information is acceptable. The acceptance information is sent to content server application 1112. If the acceptance information indicates that the payment information was accepted, content server application 1112 sends a request to content management server application 616 to install the selected content at the selected peer(s).

Content management server application 616 sends the install request to content management application 614 as discussed previously. For example, first agent 301a interacts with content distribution component 116b and internet peering component 118b of content server device 1110. Content management application 614 may send a request for content through deployment service 600 and content distribution component 116a without a hint as to the content server device 1110. Content management application 614 may also send a request to Internet peering component 118a to join a peer group. In response, Internet peering component 118a may send a join peer group request to Internet peering component 118b of content server device 1110. In an alternative embodiment, orchestration component 132 can be used to discover super-peers. Internet peering component 118a may request a list of peer discover advertisements from the SAMI API 134 and determine whether more are needed. Internet peering component 118b may simultaneously push peer discover advertisements to Internet peering component 118a at the discretion of content server device 1110 or as new agents join the peer group. If there are not enough discover advertisements and the requested content cannot be acquired, content management application 614 may resend a request for content to content distribution component 116a with a hint as to the sending content server device 1110. At some point, Internet peering component 118a tells Internet peering component 118b that it is inactive (e.g., finished acquiring content).

Selection by the user of third menu item 1214 causes content selection panel 1202 to display available movies and/or music in a media interface, and selection by the user of fourth menu item 1216 causes content selection panel 1202 to display available software applications in a software application interface. Content user application 1116 utilizes the functionality of host infrastructure 102a, SAMI 104a, content distribution component 116a, Internet peering component 118a, and content management application 614 to receive, to install, to update, etc. content stored at content database 1108, at peer management database 306, and at first and second advertisement databases 1109, 1120 and presented in content user interface display 1200. Content optionally may be ‘played’ by content user interface 1118 or by a separate application such as a media player or game player. For example, by ‘double-clicking’ on an icon 1210, a game player or a media player may be opened to allow the user to begin accessing the selected content.

In an exemplary embodiment, the user may use the browser application to communicate with content server application 1112 and to download and install content management agent infrastructure 622, content user application 1116, and content user interface 1118, which may automatically instantiate a content user agent at content consumer device 1114. The user may use the mail application to register with the content server application 1112 as known to those skilled in the art both now and in the future. In an alternative embodiment, the user may register with the content server application 1112 using the browser application as known to those skilled in the art both now and in the future.

The content user agent establishes communication with a content server agent instantiated at content server device 1110. The content user agent also establishes communication with other peer agents using the capabilities of SAMI 104a, content distribution component 116a, Internet peering component 118a, and content management application 614. The content user agent and other accessible peer agents may form a peer group. Peer groups may be reorganized for efficiency. The peer group may comprise any number of peer agents. As discussed previously, the content user agent may obtain the requested content from other peer agents.

With reference to FIG. 14, computing device 208 and/or peer management server 302 may include a display 1400, an input interface 1402, a communication interface 1404, a memory 1408, a processor 1408, agent infrastructure 134, and one or more applications 1410. Different and additional components may be incorporated into computing device 208 and peer management server 302. Display 1400 presents information to a user of computing device 208 and/or peer management server 302. For example, display 1400 may be a thin film transistor display, a light emitting diode display, a liquid crystal display, or any of a variety of different displays known to those skilled in the art now or in the future.

The input interface 1402 provides an interface for receiving information from the user for entry into computing device 208 and/or peer management server 302. Input interface 1402 may use various input technologies including, but not limited to, a keyboard, a pen and touch screen, a mouse, a track ball, a touch screen, a keypad, one or more buttons, etc. to allow the user to enter information into computing device 208 and/or peer management server 302 or to make selections presented in a user interface displayed on display 1400. Input interface 1402 may provide both an input and an output interface. For example, a touch screen both allows user input and presents output to the user.

Communication interface 1404 provides an interface for receiving and transmitting calls, messages, files, and any other information communicable between devices. Communications between computing device 208 and/or peer management server 302 and other devices may use various transmission technologies and media as known to those skilled in the art both now and in the future.

Memory 1406 is an electronic holding place for information so that the information can be reached quickly by processor 1408. For example, memory 1406 stores host infrastructure 102, agent infrastructure 134, the one or more applications 1410, etc. Computing device 208 and/or peer management server 302 may have one or more memories that uses the same or a different memory technology. Memory technologies include, but are not limited to, any type of RAM, any type of ROM, any type of flash memory, etc.

Processor 1408 executes instructions that cause computing device 208 and/or peer management server 302 to behave in a predetermined manner. The instructions may be written using one or more programming language, scripting language, assembly language, etc. Additionally, the instructions may be carried out by a special purpose computer, logic circuits, or hardware circuits. Thus, processor 1408 may be implemented in hardware, firmware, software, or any combination of these methods. The term “execution” is the process of running a program or the carrying out of the operation called for by an instruction. Processor 1408 executes an instruction, meaning that it performs the operations called for by that instruction. Processor 1408 couples to communication interface 1404 to relay received information from another device to the agent or to send information from the agent to another device. Processor 1408 may retrieve a set of instructions from a permanent memory device and copy the instructions in an executable form to a temporary memory device that is generally some form of RAM.

Exemplary agent applications 108 of agent infrastructure 134 may include content management application 614, content management server application 616, content server application 1112, content user application 1116, content user interface 1118, advertisement controller 1128. Exemplary applications 1410 may include a browser application and a mail client application.

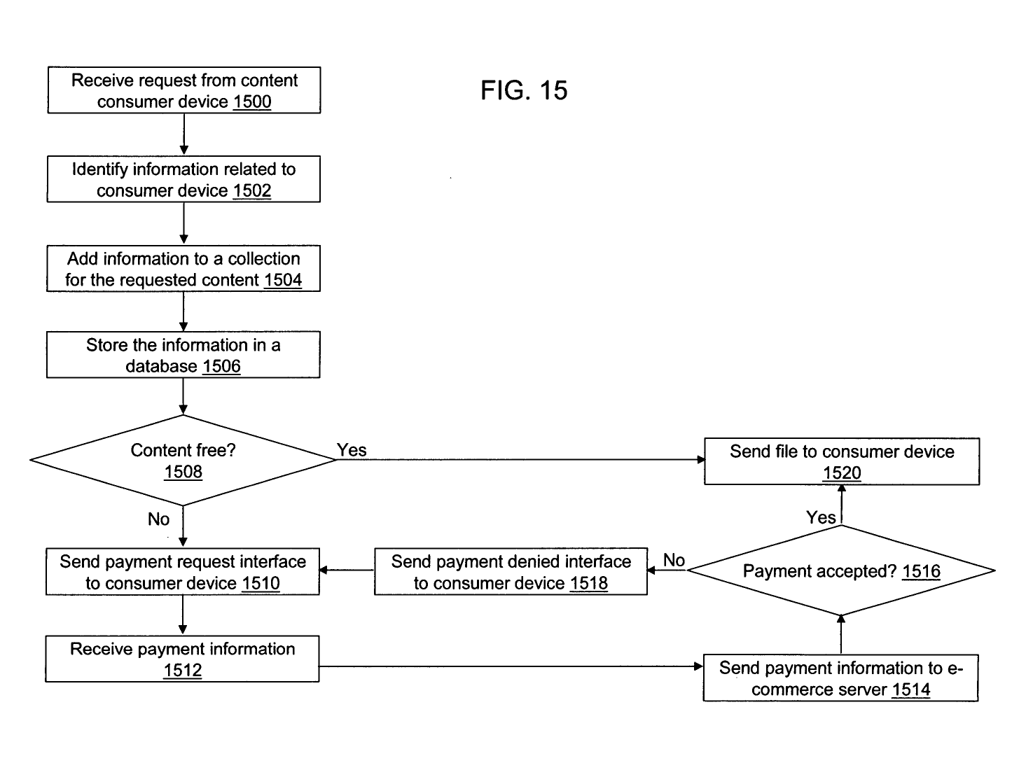

With reference to FIGS. 11 and 15, exemplary operations performed by a content server agent instantiated at content server device 1110 are described. Additional, fewer, or different operations may be included depending on the embodiment. In an operation 1500, the content server agent of device 1110 receives a request for content from content consumer device 1114. In an operation 1502, information related to identification of content consumer device 1114 is identified and extracted from the request. For example, the information may include an IP address or other information requested from a user at content consumer device 1114 such as their name, age, occupation, location, gender, income, etc. As known to those skilled in the art both now and in the future, location information for content consumer device 1114 may be obtained from the IP address. In an operation 1504, at least a portion of the identified information is added to a collection defined for the content selected by the user at content consumer device 1114. For example, the IP address and the name of the user may be added to the collection. In an operation 1506, at least a portion of the identified information is stored in a database such as peer management database 306 and/or content database 1108.

In an operation 1508, a determination of whether or not the requested content is free is performed. If the content is free, processing continues at an operation 1520. If the content is not free, processing continues at an operation 1510. In operation 1510, a payment request interface is sent to content consumer device 1114 as known to those skilled in the art both now and in the future. In an operation 1512, payment information is received from content consumer device 1114. In an operation 1514, the received payment information is sent to e-commerce service device 1122. E-commerce service 1124 hosted at e-commerce service device 1122 determines if the payment information is acceptable. The acceptance information is sent to content server device 1110. In an operation 1516, a determination of whether or not the payment information is acceptable is performed. If the payment information is accepted, processing continues at operation 1520. If the payment information is not accepted, processing continues at an operation 1518. In operation 1518, a payment denied interface is sent to content consumer device 1114 and processing continues at operation 1510.

If the acceptance information indicates that the payment information was accepted, content server application 1112 may send a request to content management server application 616 to send the requested content to content consumer device 1114 in operation 1520. The requested content may be sent to content consumer device 1114, for example, using the P2P connections of network 300 and the capabilities of agent infrastructure 134. Thus, the content may be sent from a peer having the requested content and/or from content server device 1110. Content can be updated using content management server application 616. Additionally, requests for additional content may be received and processed from peers in the P2P network.

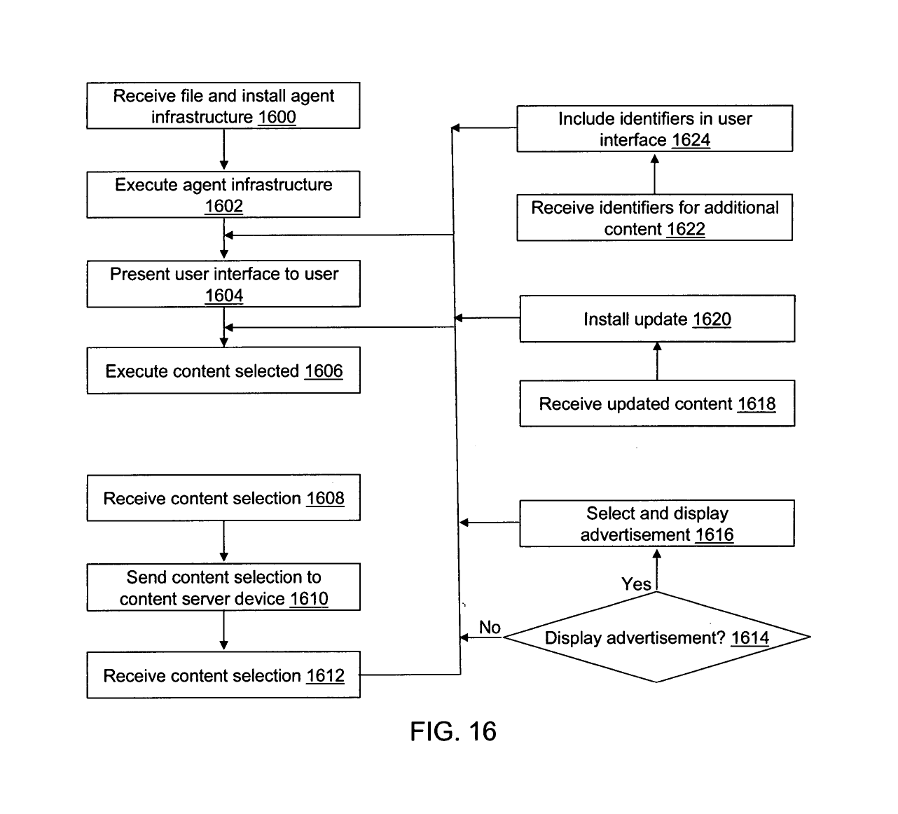

With reference to FIGS. 11 and 16, exemplary operations performed at content consumer device 1114 are described. Additional, fewer, or different operations may be included depending on the embodiment. A user of content consumer device 1114 selects content to obtain from content server device 1110. For example, using a browser, the user selects a hyperlink as known to those skilled in the art both now and in the future. The hyperlink request is sent to content server device 1110 and/or web server 304. In an operation 1600, content consumer device 1114 receives the requested content from content server device 1110 and installs the agent infrastructure. In an exemplary embodiment, the user may be requested to provide payment information. In alternative embodiments, payment information may already have been provided by the user to content server device 1110 or the requested content may be free of charge. The agent infrastructure may include host infrastructure 102a, SAMI 104a, content distribution component 116a, Internet peering component 118a, content management application 614, content user application 1116, and content user interface 1118.

In an operation 1602, a content consumer agent is instantiated by executing the installed agent infrastructure. In an operation 1604, a user interface may be presented to a user of content consumer device 1114. For example, content user interface display 1200 may be presented to the user. In an operation 1606, the content selected by the user may be executed. Operations 1600, 1602, 1604, and 1606 may be performed with or without interaction by the user. Thus, the content may be executed at content consumer device 1114 without interaction by the user after the user selects the hyperlink identifying the content.

In an operation 1608, a content selection is received, for example, from a selection of button 1304 by the user at content consumer device 1114. In an operation 1610, a request for the selected content is sent to content server device 1110. In an operation 1612, the content selection is received. Depending on the content selected by the user, installation of the content may be performed. Processing may continue, for example, at operation 1604 or at operation 1606 with execution of the newly selected content. For example, if the selected content is a movie and a movie player has already been installed at content consumer device 1114, no installation is required. The movie player may execute and play the selected movie. If the selected content is a new software application, however, installation of the content generally is performed before executing the content.

In an operation 1614, a determination is made whether or not to display an advertisement to the user. If no advertisement is to be displayed, processing may continue, for example, at operation 1604 or at operation 1606 with execution of the newly selected content. If an advertisement is to be displayed, an advertisement is selected and displayed to the user in an operation 1616. The advertisement may have been included with the file received from content server device 1110 or may be requested from the P2P network.

In an operation 1618, an update to content is received from a peer in the P2P network or from content server device 1110. In an operation 1620, the update is installed. Depending on the content received, installation may not be required. No interaction by the user is necessary. The instantiated agent performs the necessary operations.

In an operation 1622, identifiers for additional content are received from a peer in the P2P network or from content server device 1110. In an operation 1624, the identifiers are included in the user interface. For example, games available from content server device 1114 may be received and presented in game interface 1300. The identifiers may be selected based on information related to content consumer device 1114 and/or the user of content consumer device 1114.

Content server application 1112 may access advertisements contained in first advertisement database 1109 and information related to an advertisement campaign including advertisements, target segments, and goals for the campaign. Based on this information and monitoring of actions by the user at content consumer device 1114, presentation of an advertisement may be triggered at content consumer device 1114. Monitoring of actions by the user at content consumer device 1114 may be performed by content server application 1112, by content user application 1116, and/or content management application 614, and/or by a watcher server 1126 at watcher server device 1125. Additionally or in the alternative, the advertising information may be provided to content consumer device 1114 through content server application 1112. Additionally, the monitoring of actions by the user may be performed at content consumer device 1114 by content user application 1116 and/or content management application 614 which trigger presentation of an advertisement at content consumer device 1114. The presented advertisement may be stored at first advertisement database 1109 and/or at second advertisement database 1120 and/or obtained from a peer in the P2P network in the same manner as other content. Use of second advertisement database 1120 supports the presentation of advertisements to the user when the user is not connected to content server device 1110.

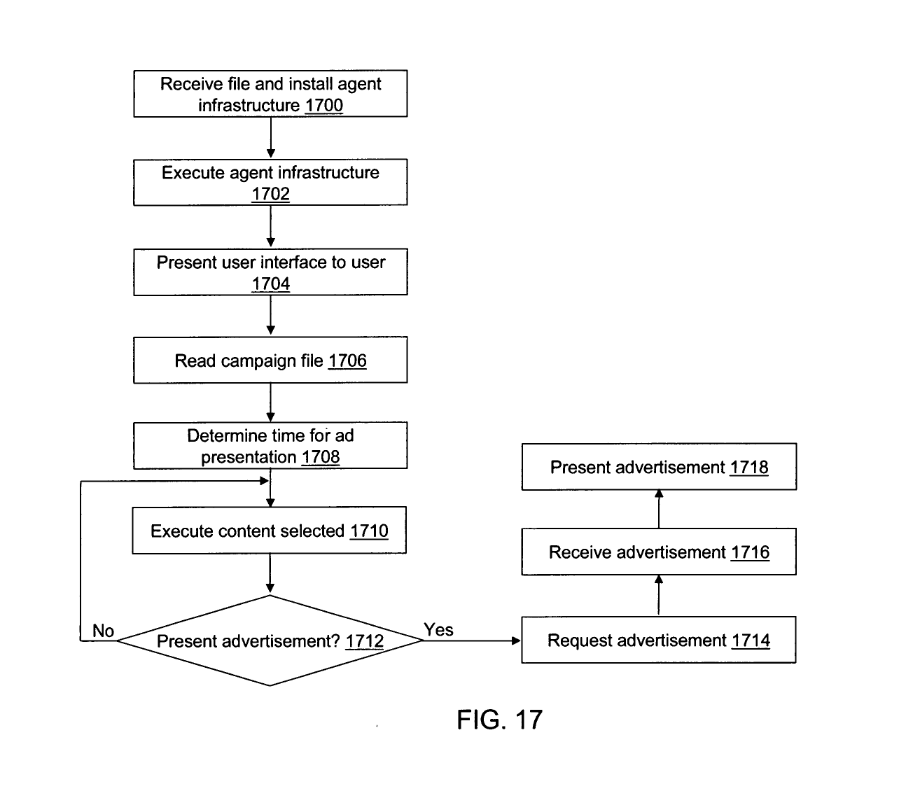

With reference to FIGS. 11 and 17, exemplary operations performed at content consumer device 1114 to present advertisements to a user are described. Additional, fewer, or different operations may be included depending on the embodiment. In an operation 1700, content consumer device 1114 receives the requested content from content server device 1110 and installs the agent infrastructure. The agent infrastructure may include host infrastructure 102a, SAMI 104a, content distribution component 116a, Internet peering component 118a, content management application 614, content user application 1116, content user interface 1118, and advertisement controller 1128.

In an operation 1702, an advertisement agent and/or a content consumer agent are instantiated by executing the installed agent infrastructure. In an operation 1704, a user interface may be presented to a user of content consumer device 1114. For example, content user interface display 1200 may be presented to the user. In an operation 1706, a campaign file is read. The campaign file is included with the file received and identifies information related to an advertisement campaign. The information includes target segments. For example, target segments identify various populations based on criteria associated with content consumer device 1114 and/or the user of content consumer device 1114. In an exemplary embodiment, the campaign file is an XML file. The campaign file can be updated as described relative to any other content by content management application 614.

In an operation 1708, the time for presenting an advertisement to the user of content consumer device 1114 is determined based on the information read form the campaign file. For example, the presentation time may be before execution of the content, during execution of the content, and/or at the end of execution of the content. One or more advertisement presentation times may be determined. The times may be relative to a start time or to a clock time as known to those skilled in the art both now and in the future. The campaign file also identifies which advertisements should be presented. For example, a list of one or more advertisements may be included in the campaign file.

In an operation 1710, the content selected by the user is executed. In an operation 1712, a determination is made as to whether or not it is time to present an advertisement to the user. If it is not time, processing continues at operation 1710. If it is time, processing continues at an operation 1714. In operation 1714, a request for an advertisement is sent to the advertisement agent. The advertisement agent determines if content consumer device 1114 is connected to the P2P network or not. If content consumer device 1114 is not connected to the P2P network, an advertisement is selected from second advertisement database 1120. For example, one or more advertisements may be sent with the file received and stored in second advertisement database 1120. If content consumer device 1114 is connected to the P2P network, the advertisement agent may send a request to peer agents in the P2P network to obtain an advertisement not already stored in second advertisement database 1120. The advertisement is received in an operation 1716. The advertisement is presented to the user of content consumer device 1114 in an operation 1718.

It is understood that the invention is not confined to the particular embodiments set forth herein as illustrative, but embraces all such modifications, combinations, and permutations as come within the scope of the following claims. For example, the present invention is not limited to a particular operating environment. Additionally, the functionality described may be implemented in a single executable or application or may be distributed among modules that differ in number and distribution of functionality from those described herein without deviating from the spirit of the invention. Additionally, the order of execution of the functions may be changed without deviating from the spirit of the invention. Thus, the description of the preferred embodiments is for purposes of illustration and not limitation.

What is claimed is:

1. A computer-readable medium having computer-readable instructions stored thereon that, upon execution by a processor, cause the processor to send a request for performing a service to a device in a network, the instructions comprising:
receiving a request for a first content from a device; and
sending a file to the device using a peer-to-peer (P2P) network, wherein the file includes the first content and a campaign file, the campaign file including information used to identify a time to present an advertisement to a user at the device, wherein the file includes programmed instructions to
install the sent file at the device;
execute the first content; and
present the advertisement at the device at the identified time as the user executes the first content.

2. A method of controlling presentation of an advertisement to a user obtaining content from a network, the method comprising:
receiving a request for a first content from a device; and
sending a file to the device using a peer-to-peer (P2P) network, wherein the file includes the first content and a campaign file, the campaign file including information used to identify a time to present an advertisement to a user at the device, wherein the file includes programmed instructions to install the sent file at the device;
execute the first content; and
present the advertisement at the device at the identified time as the user executes the first content.

3. The method of claim 2, wherein the first content comprises an application.

4. The method of claim 3, wherein the application is selected from at least one of a video player, an audio player, a text viewer, a text editor, a picture viewer, a picture editor, and a game player.

5. The method of claim 3, wherein the first content further comprises a media file.

6. The method of claim 5, wherein the media file is selected from at least one of a video file, an audio file, a text file, a picture file, and a game file.

7. The method of claim 2, wherein the advertisement is displayed when the first device is not in communication with the P2P network.

8. The method of claim 2, wherein the advertisement is selected based on the first content.

9. A method of presenting an advertisement to a user executing content at a device, the method comprising:
sending a request for a first content to a device in a peer-to-peer (P2P) network;
receiving a file from the device using the P2P network, wherein the file includes the first content and a campaign file;
installing the received file;
executing the first content;
determining a time to present an advertisement based on information read from the campaign file;
at the determined time, requesting the advertisement; and
presenting the requested advertisement.

10. The method of claim 9, wherein the first content comprises an application.

11. The method of claim 10, wherein the application is selected from at least one of a video player, an audio player, a text viewer, a text editor, a picture viewer, a picture editor, and a game player.

12. The method of claim 10, wherein the first content further comprises a media file.

13. The method of claim 12, wherein the media file is selected from at least one of a video file, an audio file, a text file, a picture file, and a game file.

14. The method of claim 9, wherein the advertisement is displayed when the first device is not in communication with the P2P network.

15. The method of claim 9, wherein the advertisement is selected based on the first content.

16. The method of claim 9, further comprising sending a request for the advertisement to a second device in the P2P network.

17. The method of claim 16, further comprising receiving the advertisement from the second device in the P2P network.
